(19) United States
(12) Patent Application Publication
(10) Pub. No.: US 2007/0198246 A1
(43) Pub. Date: Aug. 23, 2007

(54) Interactive system for building, organising, and sharing one's own encyclopedia in one or more languages

(76) Inventor: Gautam Dharamdas Goradia, Maharashtra (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/598,540

(22) PCT Filed: Feb. 18, 2005
(86) PCT No.: PCT/IN05/00051

§ 371 Date: Sep. 1, 2006

(30) Foreign Application Priority Data
Mar. 3, 2004 (IN) 253/MUM/2004

(51) Int. Cl. G06F 17/28

(52) U.S. Cl. 704/4

(57) ABSTRACT

An interactive system for building, organizing, and sharing one's own encyclopedia in one or more languages is disclosed; it being accepted that one may want to build such data based on one's personal interest, by well-defined classifications, that uses a computer system and comprising of: (i) a User Interface; (ii). a Database comprising a. an Encyclopedia Bank Database; b. a Translation Database; c. a User Database; d. a Configuration Database; (iii) At least one data input, organising and management module(s) allowing a user to input, append, modify, cross-reference, and translate well-classified data, (iv) Module allowing the user to Export data from the Database(s); (v) Module allowing the user to Import data built by another user using the same system.

### FIELD OF INVENTION

The present invention relates to an interactive System for building (including saving, appending, retrieving, modifying), organising, and sharing one's own Encyclopedia in one or more languages, it being accepted that one may want to build (including saving, appending, retrieving, modifying) and organise such data based on one's personal interest in one or more languages, by well-defined classifications like Language, Source of Information, Index Letter, Age Group, Subject, Sub subjects etc, Attach Image, Animation and/or Sound files to the same, Associate more information in the form of Files, URLs, Remarks to the same, Translate the same into one or more languages of the user's choice, Print data, as well as obtain a plurality of Reports, Cross-Reference such data, and Share such data.

### BACKGROUND OF THE INVENTION

It is a well-accepted fact that since time immemorial, people have used reference works in one form or the other for the purpose of acquiring knowledge or obtaining information about a particular topic or subject. Reference works such as encyclopedias, in particular, which usually contain information on all branches of knowledge, deserve special mention in this case. Merriam Webster defines an encyclopedia as:
“a work that contains information on all branches of knowledge or treats comprehensively a particular branch of knowledge usually in articles arranged alphabetically often by subject”

Oxford defines an encyclopedia as:
“a book or set of books giving information on many subjects or on many aspects of one subject, typically arranged alphabetically.”

Encyclopedia Britannica defines an encyclopedia as:
reference work that contains information on all branches of knowledge or that treats a particular branch of knowledge in a comprehensive manner. From the above definitions, and as is a well-accepted fact, encyclopedias provide information in an indexed manner, thus making it easier for people to look up information. Articles in an encyclopedia, whether general or subject-specific, are usually indexed alphabetically or topic-wise.

It is a well-accepted fact that some encyclopedias are prepared for specific fields, subjects, or audiences. For example, some encyclopedias are prepared exclusively for children, some for scholars and specialists, some for students, teachers and educators, and some for family audiences.

It is a well-accepted fact that people preserve articles appearing in newspapers, magazines, scientific journals and other publications, or over the Internet, for the purpose of future reference. This is generally done by means of keeping such information in scrap books, files, or electronic files and folders. It would be helpful for such people if they could be able to search and retrieve, modify and share a particular article swiftly and efficiently.

It is a well-accepted fact that there are many publishing houses and companies involved in publishing encyclopedias, in printed or electronic form, from time to time. It is also a well-known fact that in order to receive updated information, people have to wait for the updated editions of such encyclopedias to be published by such companies, which may often take a considerable period of time. It would be therefore be useful for users to be able to store updated information in a well-classified manner, as soon as updated information is received.

It is a well-accepted fact that encyclopedias usually provide maps or illustrations which complement the information given in the text and make the articles presentable and reader-friendly, thus enriching the process of learning and informing.

It is a well-accepted fact that some people might be having additional information on a particular topic or subject, which they might want to share with others.

It is a well-accepted fact that encyclopedias provide cross-references for articles so that the reader can access more detailed information on a particular topic or subject.

It is a well-accepted fact that people are unable to create their personalized encyclopedias, as the creation of encyclopedias is a complex and laborious process involving a large amount of resources and infrastructure. Moreover, conventional encyclopedias usually do not allow people to build, store, update, modify or cross-reference information according to their needs and interests. The best people can do currently, with respect to creating their own banks of information, is to store information in files, and folders. However, when there are too many files and folders, it would be very difficult to use them effectively, share them with ease, make changes across several files, index the same with ease, and use a plurality of conditions to search for information. It is a well-accepted fact that information stored in a well-classified database, with meaningful classifications, can be utilized very effectively.

It is a well-accepted fact that generally one does not come across an encyclopedia that may contain information in more than one language.

It is well-accepted fact that when people look up conventional encyclopedias, they would find it very difficult to back-track, i.e. to go back and forth between information that they may need across several articles.

It is a well-accepted fact that people generally cannot remember a large amount of data whether by classifications or not, without external help, and it would be very helpful if there were to exist a System that would help people to Add, Retrieve, Modify, Delete, Print, Export, Import, Cross-reference such data, thereby helping people to remember such data for use in daily life, to increase their knowledge on the same.

US2001003040—Virtual Learning Environment For Children

A virtual learning system environment which provides for progressive education of children, at their own pace, through enhancement in -both language arts (e.g. spelling, reading comprehension) and physical skills (interactive prompts). The system of this invention includes a microphone for sensing an audible word or command, a video camera for sensing bodily movement, and means for effecting a computer generated response to said audible word or command, or said bodily movement, wherein said response includes both graphical depiction of the letters of said audible word or command, an object image corresponding to bodily movement or said audible word or command, and an action or object related to said bodily movement or said audible word or command, or any combination thereof, so as to effect a progressive learning or teaching experience. The system also provides for direction to a pathway alternative to said system based upon a series of links, similar to the Encarta Encyclopedia, to web pages and the like, where it directs the child to additional sources of information concerning the one or more aspects of the learning exercise. In addition, the system allows for a live or computer mediator to monitor the progress of the learning experience.

US2002032672—Method and Apparatus for Formatting Information within a Directory Tree Structure into an Encyclopedia-Like entry

Method and apparatus for formatting information within a directory tree structure into an encyclopedia-like entry. The method includes performing a search by utilizing a selective one or more search methodologies including keyword search, hierarchical search, dichotomous key search, and parametric search to correlate a search criteria to a searchable database for generating one or more matching items, wherein the searchable database is formatted in the directory tree structure. The directory tree structure includes nodes comprising a collection of related data and branches comprising links between the nodes. Each matching item represents a node from within the directory tree structure. The method further includes selecting one of the matching items, formatting the collection of related data corresponding to the node of the selected matching item into an encyclopedia-like entry, and displaying the encyclopedia-like entry corresponding to the node of the selected matching item. The encyclopedia-like entry can include text, graphics, links to related topics within the directory tree structure, links to related web sites external to the directory tree structure, or any combination thereof. Utilizing the search methodologies can be performed by a server, preferably accessible over the internet through the public switched telephone network.

U.S. Pat. No. 5,321,609—Electronic Encyclopedia

A location technique in an electronic encyclopedia for presenting relevant articlcs in response to a user input of a query term. The technique employs a user controlled hierarchy of filter parameters. The user selects a subset of the identifying parameters into which all articles are classified; each article being classified into at least one identifying parameter. There are 107 parameters disclosed. The encyclopedia automatically locates each article that employs the input or query term in each of the parameters selected by the user. The 107 identifying parameters are divided into four Groups. The articles presented to the user are only those articles which are common to each of tex up to four Groups into which the user selected parameters are divided. An optimally useful set of articles is provided to the user. By a combination of the union of the articles within the user selected parameters within each of the Groups together with the intersection of the articles between Groups.

JP2003085181—Encyclopedia System

PROBLEM TO BE SOLVED: To provide the function for forming encyclopedia information, and allowing a user to easily retrieve an unknown term by extracting knowledge information on the term from a Web page. SOLUTION: This encyclopedia system is roughly composed of an encyclopedia information forming part for forming an encyclopedia information database by using a Web site retrieving engine from the Web page on the Internet, and a question answering part for retrieving and outputting an investigation desired term and information inputted by the user from the encyclopedia information database. The encyclopedia information forming part is composed of a retrieving part for retrieving a related page from a page on WWW to the term inputted by the user, an extracting part for extracting a term explanation from the retrieved page, and an organizing part for forming the encyclopedia information by arranging a term explanation part of the extracted information, This constitution can provide the function for allowing the user to easily retrieve the unknown term by forming the encyclopedia information of an easily usable form.

U.S. Pat. No. 5,832,472—Enhanced Electronic Encyclopedia

An enhanced electronic encyclopedia is provided. The encyclopedia includes a database of articles stored in one or more memories. The database of articles includes base articles with article titles, article text and an objective rating. The database of articles also includes supplemental articles corresponding to base to articles with a selected objective rating. Each supplemental article has an icon which identifies characteristics of the supplemental article. The encyclopedia also includes a processor, an input device and an output device. A method for creating an enhanced electronic encyclopedia is also provided.

CA2101093—Computerized Encyclopedia And User Interface Therefor

An information presentation apparatus comprising a computer program executed by a computer for accessing an encyclopedia stored in an electronic format in the computer's data storage. The encyclopedia comprises a database of articles and associated multimedia elements, including graphics, animations, and sounds. The computer program provides four pathways for accessing the articles in the encyclopedia, including an alphabetical list pathway, a topic hierarchy pathway, a search and retrieval-pathway, and a multimedia browser pathway.

The prior art systems described in the foregoing descriptions have an inherent limitation, in that, they do not allow the user to build, organise, and share their own encyclopedia in one or more languages.

Therefore, by dint of determined research and intuitive knowledge, our inventor has developed an interactive System that enables users to build (including saving, appending, retrieving, modifying) and organize their own encyclopedias by well-defined classifications, cross-reference various pieces of information, translate the same into one or more languages, and share the same with other users of this System through export and import.

### BRIEF SUMMARY OF THE INVENTION

An object of the present invention is to allow the user to build, organise, and share one's own Encyclopedia in one or more languages, it being accepted that one may want to build (including saving, appending, retrieving, modifying) and organise such data,in one or more languages, based on one's personal interest and further store it by well-defined classifications like Language, Source of Information, Index Letter, Age Group, Subject, Sub subjects etc, such classification of data not restricted to any already provided data.

Yet another object of the present invention is to maintain a history of the records viewed by the user in such an Encyclopedia.

Yet another object of the present invention is to allow the user to cross-reference information in such an Encyclopedia.

Yet another object of the present invention is to allow users to FIND data rapidly and efficiently by none or one or more FIND conditions, wherein the FIND conditions to find the Records from the Database(s) are defined by none or one or more Criteria like the Date, Record ID, Language, Entry Title, Source of Information, index Letter, Age Group, Subject, Sub Subjects etc as well as by keywords, wildcard characters, by whether or not a Record has File

Attachments/Associations and/or Attachment/Association Remarks, whether or not the Record has been imported and further by Import Remarks, and/or whether or not a Record has been Bookmarked and further by Bookmark Remarks, and/or whether or not a Record is marked as “Private” or “Public” and/or “Favourite”, The user can exercise the option of using the above conditions to bring forth or avoid Records by the specified conditions.

Yet another object of the present invention is to allow the user to add Bookmark Remarks, Attachments, Associations of Files, including Media files, URLs and more Remarks and further Attachment/Association Remarks to the Records. Yet another object of the present invention is to allow users to mark Records as “Public” or “Private”, individually or globally, and assign the same to specific users or user groups.

Yet another object of the present invention is to allow users to mark selected Records as “Favourite”, individually or globally, and assign the same to specific users or user groups.

Yet another object of the present invention is to allow users to Navigate efficiently between the Records.

Yet another object of the present invention is to allow users to Modify data individually and globally, and further selectively.

Yet another object of the present invention is to allow users to share data created by the users using the Export/Import/Print utilities, such Exporting/Importing/Printing of data capable of being done selectively.

Yet another object of the present invention is to allow users to delete the data, individually or globally, sending the deleted data to the Recycle Bin of the System, and further restoring or deleting the same, singularly or plurally.

Yet another object of the present invention is to provide various Reports selectively and having the further utility of customising the same.

Yet another object of the present invention is to provide the necessary Tools to the user for better customisation and maintenance of the System in various ways.

Yet another object of the present invention is to allow one or more module(s)/utility(s) to operate within a browser and/or other viewing and/or processing programs.

Yet another object of the present invention is to provide a utility for creating, modifying, deleting, printing, navigating, finding Masters like Language, Source of Information, Age Group, Subject, and Sub subjects with sufficient security so as not to allow the deletion of any Master of a Record that may be in use.

Yet another object of the present invention is to provide users with a Translation utility, allowing the user to consider any Record as a parent language Record and Translate the same into one or more languages of the user's choice, the translation activity happening from a Translation Module which is invoked in the Encyclopedia Bank Module, and further that all of the features and/or utility(s)/functionality(s) available in case of the parent language Record are available in case of its translation.

Yet another object of the present invention is to allow the user to Print any Record of the user's choice as well as obtain a plurality of Reports.

Yet another object of the present invention is to allow the user to input and/or modify data in the Database(s) by Voice input, with or without a conjunction of input made by keyboard support, and/or to use any other utility(s)/functionality(s) of the System, as may be supported by the System for such use, by Voice Command, and further to allow the user to receive Voice Output of the data so entered/modified by the user.

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which the following are represented in an illustrative and non-restrictive way:

FIG. 1 is the diagram of the System block of the present invention.

FIG. 2 is the diagram of the Multiple User System of the present invention

FIG. 3 is the diagram of the Outline of the System Process of the present invention

FIG. 4 is the diagram of the System Function of the Encyclopedia Bank Module of the present invention

FIG. 5 is the diagram of the System Operation of the Encyclopedia Bank Module of the present invention

FIG. 6 is the diagram of the System State Transition of the Encyclopedia Bank Module of the present invention

FIG. 7 is the diagram of the System Function of the Global Changes Module of the present invention

FIG. 8 is the diagram of the System Operation of the Global Changes Module of the present invention

FIG. 9 is the diagram of the System State Transition of the Global Changes Module of the present invention

FIG. 10 is the diagram of the System Function of the Reports Module of the present invention

FIG. 11 is the diagram of the System Operation of the Reports Module of the present invention

FIG. 12 is the diagram of the System State Transition of the Reports Module of the present invention

FIG. 13 is the diagram of the System Function of the Export Module of the present invention

FIG. 14 is the-diagram of the System Operation of the Export Module of the present invention

FIG. 15 is the diagram of the System State Transition of the Export Module of the present invention

FIG. 16 is the diagram of the System Function of the Import Module of the present invention

FIG. 17 is the diagram of the System Operation of the Import Module of the present invention

FIG. 18 is the diagram of the System State Transition of the Import Module of the present invention

FIG. 19 is the diagram of the System Function of the Recycle Bin Module of the present invention.

FIG. 20 is the diagram of the System Operation of the Recycle Bin Module of the present invention

FIG. 21 is the diagram of the System State Transition of the Recycle Bin Module of the present invention

FIG. 22 is the diagram of the System Function of the Tools/Help Menu Options Module of the present invention

FIG. 23 is the diagram of the System Operation of the Tools/Help Menu Options Module of the present invention

FIG. 24 is the diagram of the System State Transition of the Tools/Help Menu Options Module of the present invention

FIG. 25 is the diagram of the System Function of the Translation Module of the present invention

FIG. 26 is the diagram of the System Operation of the Translation Module of the present invention

FIG. 27 is the diagram of the System State Transition of the Translation Module of the present invention

FIG. 28 is the diagram of the System Function of the Master Module of the present invention

FIG. 29 is the diagram of the System Operation of the Master Module of the present invention

FIG. 30 is the diagram of the System State Transition of the Master Module of the present invention

### DETAILED DESCRIPTION OF THE PRESENT INVENTION

A detailed description of the preferred embodiments and best modes for practicing the present invention are described herein.

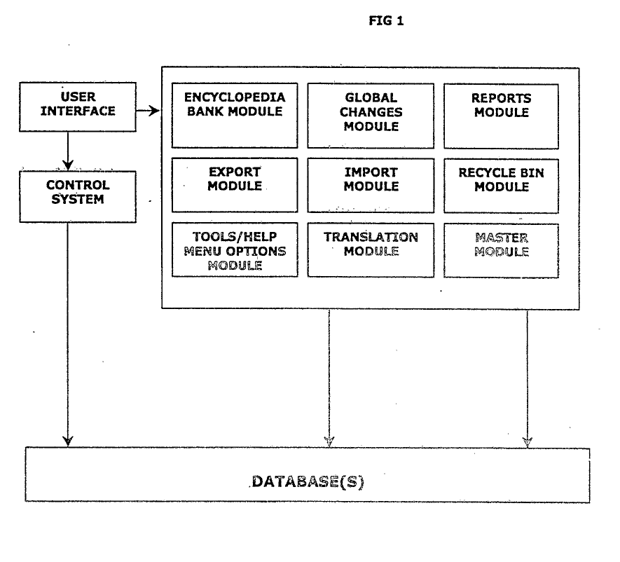

An interactive System for building (including saving, appending, retrieving, modifying), organising, and sharing one's own encyclopedia in one or more languages, wherein FIG. 1 is the diagram of the System Block consisting of different functional blocks and their interaction of the present invention. The User Interface(s) render the user's actions, and with the help of the Control System transmits the appropriate requests to the Database(s). The Control System acts as the bridge between the User Interface(s) and the Database(s).

The Database(s) consists of Encyclopedia Bank Database, Translation Database, User Database and the Configuration Database. Encyclopedia Bank Database is the reservoir of an extensible collection of well-classified data and further stores the data user wise. The Translation Database is the reservoir of the translated data. The User Database is the reservoir of the user information and also contains the history of past user interaction with the System. The Configuration Database is the reservoir of the options used for the Customization of the System.

If the user requests for the Encyclopedia Bank Module through the User Interface, then the Control System asks the Database Management System to find the corresponding data from the Database(s), resulting in the display of the relevant data, if available. The user then interacts further with the Encyclopedia Bank Module through the User Interface with respect to the utilities available in this Module.

If the user requests for the Global Changes Module through the User Interface, then the Control System asks the Database Management System to find the corresponding data from the Database(s), resulting in the display of the data, if available. The user then interacts further with the Global Changes Module through the User Interface with respect to the utilities available in this Module.

If the user requests for the Reports Module through the User Interface, then the Control System asks the Database Management System to find the corresponding data from the Database(s), resulting in the display of the relevant data, if available. The user then interacts further with the Reports Module through the User Interface with respect to the utilities available in this Module.

If the user requests for the Export Module through the User Interface, then the Control System asks the Database Management System to find the corresponding data from the Database(s), resulting in the display of the relevant data, if available. The user then interacts further with the Export Module through is the User Interface with respect to the utilities available in this Module.

If the user requests for the Import Module through the User interface, then the Control System asks the Database Management System to retrieve the corresponding data from a valid database file resulting in the display of the relevant data, if available. The user then interacts further with the Import Module through the User Interface with respect to the utilities available in this Module.

If the user requests for the Recycle Bin Module through the User Interface, then the Control System asks the Database Management System to find the corresponding data from the Database(s) resulting in the display of the relevant data, if available. The user then interacts further with the Recycle Bin Module through the User Interface with respect to the utilities available in this Module.

If the user requests for the Tools/Help Menu Options Module through the User Interface, then the Control System asks the Database Management System to retrieve the corresponding Options available from the Database(s). The user then interacts further with the Tools/Help Menu Options Module through the User Interface with respect to the utilities available in this Module.

If the user requests for the Translation Module through the User Interface, then the Control System asks the Database Management System to find the corresponding data from the Database(s), resulting in the display of the relevant data, if available. The user then interacts further with the Translation Module through the User Interface with respect to the utilities available in this Module.

If the user requests for the Master Module through the User Interface, then the Control System asks the Database Management System to find the corresponding data from the Database(s) resulting in the display of the relevant data, if available. The user then interacts further with the Master Module through the User Interface with respect to the utilities available in this Module.

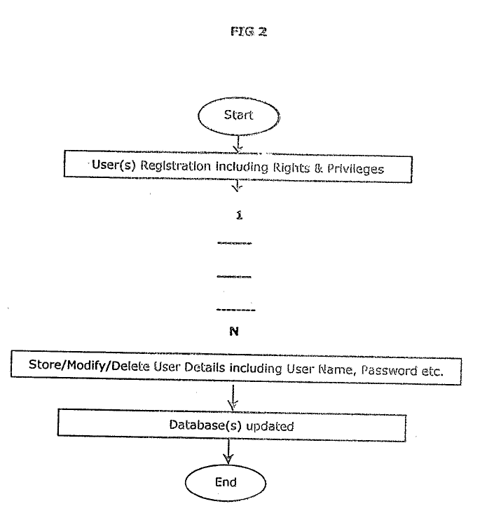

FIG. 2 is the diagram of the Multiple User System of the present invention. It explains that multiple users can use the System at the same time, and also explains that the System can be controlled by rights and privileges. It further allows the user to Store/Modify/Delete the User Details including User Name, Password etc. in the Database(s). Whenever a user wishes to log in to the System, the user has to provide a User Name and password. The user can further modify an existing password. Further, there is also a utility which allows the creation of new users.

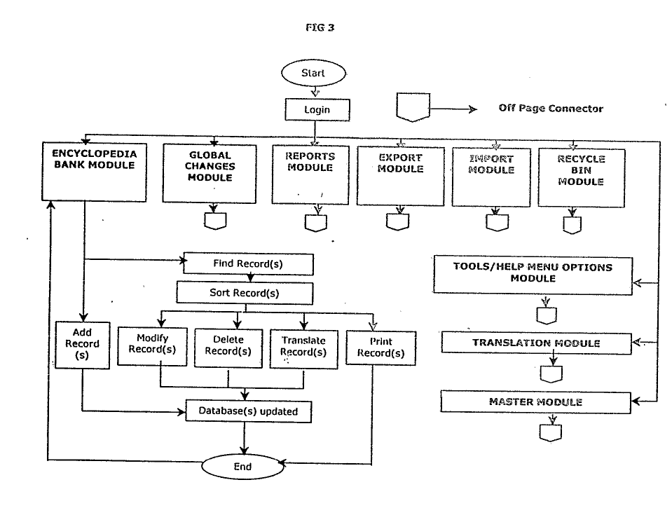

FIG. 3 is the diagram of the outline of the System Process of the present invention. It exhibits the Modules of the System and their main functions.

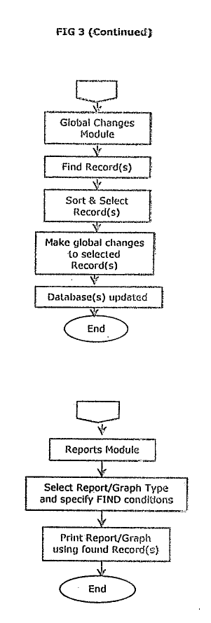

FIGS. 4 to 9 explain the System Function, System Operation, and System state Transition respectively of the Encyclopedia Bank Module and Global changes Module respectively of the present invention. The Encyclopedia Bank module allows the user to build, store, and organise data by well-defined classifications. The Global Changes Module allows the user to globally Modify part(s) of Records, globally Delete Records, globally Bookmark Records, globally mark Records as “Public” or “Private”, and/or “Favourite”, globally Associate additional information in the form of File(s)/URL(s)/Remark(s) to Records, globally Attach a File such as an Image, Animation, or a Sound file to Records, or globally Translate Records.

FIG. 4 is the diagram of the System Function of the Encyclopedia Bank Module of the present invention. The architecture of this Module comprises the following functions, which allow a user to build, store, and organise data by well-defined classifications with the help of the User Interface.

The Encyclopedia Bank Module through the User Interface causes the Control System to find and retrieve the relevant data from the Database(s). The Module allows a user to:
Enter/Select a Language
Build, store, and organise data by well-defined classifications
Copy Current Entry
Find the available hierarchy(s) of Subject and Sub Subjects

Find related Record(s) having the same Classifications as that of the current Record, as may be defined by the user
Attach/Associate File(s)/URL(s)/Remark(s) to Record(s)
Find existing Record(s) from the Database(s) by none or one or more FIND conditions
Sort and Select Record(s)
Modify Record(s)
Add/Modify Record(s) by Voice Input as well as receive Voice Output of Record(s)
Translate Record(s)
Delete Record(s)
Go to a Record and Navigate between Records
Cross-reference Record(s)
Print Record(s) by various Print conditions
Bookmark Record(s)
Mark Record(s) as “Public” or “Private”
Mark Record(s) as “Favourite”
Send Record(s) via Email and/or Network Messaging
Export Record(s)

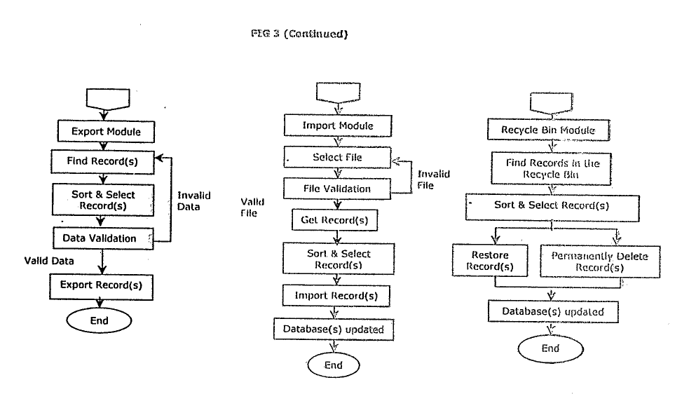

FIG. 5 describes the System Operation of the Encyclopedia Bank Module explaining that the Module is based on user actions. The Encyclopedia Bank Module accepts data in one or more languages (such data capable of being accepted from more than one user at the same time), with or without voice, by well-defined classifications like (1) Date (the same being generated automatically by the System and/or which can be modified by the user if needed), (2) Language (the user selects from the available languages or adds a new one) (3) Source of Information (to record the source from where the user obtained the details the user is entering—EXAMPLE—If the user may have built data based on a particular book or magazine or dictionary or website, say “XYZ”, then the Source of Information would be “XYZ”, (4) Index Letter (to record the Index Letter for the purpose of indexing—EXAMPLE—If an Article is titled “SOLAR SYSTEM”, then its Index Letter would be “S”, (5) Age group (to record the relevant Age Group—EXAMPLE—an Article on the game of ‘tic tac toe’ could be classified under the Age Group JUNIORS while an Article on the subject of Physics could be classified under the Age Group SENIORS), (6) Subject (to record the subject—EXAMPLE—an Article on soccer may be classified under the Subject ‘SPORTS’), (7) Sub Subjects (to record the sub subjects to which the Record belongs—EXAMPLE—if a user has classified an Article on the Solar System under the Subject ‘SCIENCE’, then the user may want to further classify the same upto 2 levels {Sub Subjects} e.g. SUBJECT>SCIENCE>SUB SUBJECT>ASTRONOMY>SUB SUBJECT2>SOLAR SYSTEM.

When the user enters this Module, the Control System brings forth the User Interface of .this Module from where the user can enter/select a Language, build and store data by well-defined classifications, find the available hierarchy(s) of Subject and Sub Subjects, find related Record(s) having the same Classifications as that of the current Record, as may be defined by the user, Attach/Associate File(s)/URL(s)/Remark(s) to Record(s), Find existing Record(s) from the Databaseks) by none or one or more FIND conditions, Modify Record(s), Add/Modify Record(s) by Voice Input as well as receive Voice Output of Record(s), Translate Record(s), Delete Record(s), View the current Find result, Go to a Record and Navigate between Records, Cross-reference Record(s), Print Record(s) by various Print conditions, Bookmark Record(s), Mark Record(s) as “Public” or “Private” as well as “Favourite”, Use the ‘Zoom’ option, Send Record(s) via Email and/or Network Messaging, view Import Status, and Export Record(s). The user can also choose not to use any of these functionalities and close the User Interface to come out of the Module. All of these functionalities are described below in detail.
If the user chooses to build and store data, the user must first enter/select a Language. When the user chooses to build data, the Control System brings forth a User Interface which prompts the user to copy the current Record if any, facing the user, in terms of data input fields comprising of the Header (Classifications), Entry Title, the text of the Record, Remarks, and/or Attachment/Association(s), such “Copy Current Entry” utility being of immense use to the user to simplify the creation of Record(s) having at least common Classifications. If a user selects to copy the Header (Classifications), then the Classifications under which the current Record facing the user is classified, will be copied.—EXAMPLE—if a user has an existing Record classified as:
INDEX LETTER: S
TITLE: SOLAR SYSTEM
SOURCE OF INFORMATION: PROF. BROWN
AGE GROUP: SENIORS
SUBJECT: SCIENCE
SUB SUBJECT1: ASTRONOMY
SUB SUBJECT2: STARS

And the new Record created by the user also happens to be failing under the above Classifications, the “Copy Current Entry” utility would make it easier for the user to enter a new Record, in that, the user would not have to reclassify the new Record. If a user selects to copy the text of the Record and Remarks, the text and Remarks of the current Record facing the user will be copied. It user selects to copy entries made in other data input fields for the current Record facing the user, then such entries will be copied accordingly. If a user selects to copy the Attachment and/or Associations to the current Record facing the user, then the Attachment and/or Associations will be copied accordingly. If a user chooses not to use this “Copy Current Entry” utility, then the Control System gets notified and blanks out all the relevant data input fields for new data input by the user.

The user can then check whether the user is duplicating an entry by choosing to find the available hierarchy of Subject and Sub Subjects by which the Record(s) are stored in the Database(s), as well as Record(s) having the same Classifications as that of the current Record facing the user. The hierarchy of Subject and Sub Subjects is found according to what the user has entered as Subject and/or Sub Subjects—EXAMPLE—If the user has not entered or selected any Subject and/or Sub Subjects, the Control System brings forth all the available hierarchy(s) of Subject and/or Sub Subjects by which the Record(s) are classified and stored in the Database(s). If the user has entered or selected the Subject as “SCIENCE”, the Control System brings forth the hierarchies of Subject and Sub Subjects pertaining to the Subject “SCIENCE”. Further if the user has entered or selected “SCIENCE” in either the Subject or Sub Subjects, the Control System brings forth hierarchy(s) of Subject and Sub Subjects where “SCIENCE”is there in either the Subject or any of the Sub Subjects. The user can select any hierarchy from those brought forth and can enter this hierarchy in the data input fields provided for Subject and Sub Subjects in the User Interface.

If the user chooses to find Record(s) having the same classifications as that of the current Record facing the user, the Control System brings forth a User Interface showing a grid which displays the Find Results accordingly.

The user can Add a Record by entering accordingly in the relevant data input fields provided for the purpose. It is mandatory for the user to do this, else the Record will not be saved in the Database(s). The user can enter or select relevant classifications in relevant data input fields for the Record as mentioned above. The user can enter and/or store the text of the Record in a data input field provided for the purpose. The user also has the option of adding images and other types of graphics in this data input field. This data input field provides the user with various editing and formatting options for text and graphics. The user also has a ‘Zoom’ option whereby the contents of this data input field are shown as zoomed in a separate User Interface. The user can also add, modify, and view the contents in the data input field through this ‘zoomed’ User Interface. The user can also use this ‘Zoom’ option while navigating between Records. The user can further enter additional information about the Records, such as Entry Title and further additional Remarks if any, in data input fields provided for the purpose. The user can further choose to Attach/Associate additional information like File(s) including Image, Animation or Sound File(s), URL(s), and Remark(s) to the Record—EXAMPLE—The user may want to Attach a File such as an Image, Animation, or a Sound file, or the user may want to Associate more information by means of associating some information that may be on a File or a Web Site, and hence the user would Associate a File or URL. The user can open and view such File(s), provided the relevant applications for opening, the File(s) are installed on the user's computer system. Further, in case of a File Attachment the user can open and view the same in a separate User Interface. In case of a URL, the same would be opened by the Control System provided the user is connected to the Internet. The user may also simply wish to Associate a REMARK to the Record. Such REMARKS are displayed to the user on demand.

In case the user wants to Attach/Associate File(s), the Control System brings forth a User Interface from where the user must browse for and select the File(s), from a computer system. In case the user wants to Associate URL(s) or Remark(s), the user must enter the same into a data input field provided for the purpose. The user can further enter Remarks about each Attachment/Association in data input fields provided for the purpose. The user can further delete the Association(s) or remove the Attachment that the user might have given at this time. The Control System updates the Database(s) in this case. The user also has the further option of viewing the Attached File using the ‘Zoom Attachment’ option whereby the contents of the File are shown as zoomed in a separate User Interface.

After the user adds a Record in the manner described above and chooses to save it, the Control System saves the same accordingly, generates a new Record Id for the same, and updates the Database(s). The Control System generates a new Record ID each time a new entry is made by a user or when a Record is imported by the user.

If the user wants to find existing Record(s) stored in the Database(s), the Control System brings forth a User Interface from where the user enters/selects a FIND criterion, and based on the same, the Control System finds and retrieves the Record(s) from the Database(s). The user can find Record(s) by none or one or more FIND conditions. The user can find Record(s) stored in the Database(s) by a Date and Record Id range.—EXAMPLE—If the user wants to find Record(s) created between particular dates, the user has to select the appropriate dates in the From Date and To Date fields in the User Interface. If the user wants to find Record(s) by their Record ID; then the user has to enter the Record of the desired Record(s) in the From Record Id field and To Record Id fields of the User Interface. If the user wishes to find Record(s) in the German Language, the user has to enter or select GERMAN in the Language field in the User Interface. If the user wishes to find Record(s) pertaining to the Source of Information “XYZ”, the user must enter or select the Source of Information “XYZ” in the Source of Information field in the User Interface. If the user wishes to find Record(s) classified under the Age Group ‘HIGH SCHOOL’, the user must enter or select the Age Group ‘HIGH SCHOOL’ in the Age Group field in the User Interface. If the user wishes to find Record(s) which have the Index Letter ‘K’, then the user must enter ‘K’ in the Index Letter field of the User Interface. If the user wishes to find Record(s) which have a Entry Title ‘ABC’, the user must enter or select ‘ABC’ in the Entry Title field of the User interface. If the user wishes to find Record(s) classified under the 'subject ANIMAL WORLD, the user must enter the subject ANIMAL WORLD in the Subjects field in the User Interface. The user can further find Record(s) pertaining to any of the Sub Subjects.—EXAMPLE—If the user wishes to find Record(s) classified under the Sub Subject hierarchy SUB SUBJECT1>TERRESTRIAL ANIMAL>SUB SUBJECT2>MAMMAL, the user can enter either of the Sub Subjects in the Sub Subjects field. The user can also enter relevant keywords in the keywords field of the User Interface, which would bring forth those Record(s), which contain the exact match or part thereof of the keywords entered by the user. The user can enter more than one keyword and can also choose to include or exclude the whole or part of any keyword—EXAMPLE—The user can enter one or more keywords separated by a space in the keywords field, and further the user can add a “+” separator or a “−” separator to include or exclude the subsequent word with respect to the immediately preceding word. The user can further enter the keyword within quotation marks to find Record(s) containing the exact match for the keyword. The Control System searches for the keyword in all the data input fields for the Records and brings forth the Find Results accordingly. The user can further find Record(s) by a criteria of whether or not the Record(s) have been Bookmarked. In case where the Record is Bookmarked, the user can find it by entering the appropriate Bookmark Remarks that the user may have assigned to the Record at the time of bookmarking the Record in the Module. The user has the further option of excluding the entered Bookmark Remark.—EXAMPLE—If the user has entered the Bookmark Remarks as “XYZ” and chooses to exclude the same, then the Control System will avoid showing those Record(s) in the Find Results where “XYZ” is there in the Bookmark Remarks. The user can further find Record(s) by a criteria of whether or not the Record(s) have been marked as “Public” or “Private” as well as “Favourite”. The user can further find Record(s) by a Criteria of whether or not the Record(s) have Associations and/or File Attachments. If the user selects to find Record(s) that have File Attachments, the user must further select the type of the File Attachment as either an Image, Animation, or a Sound file. The user has a further option to exclude the type of the File Attachment.—EXAMPLE—If the user selects the type of the File Attachment as ‘IMAGE’ and chooses to exclude the same, the Control System will bring forth Find Results showing those Record(s) which do not have Image files as Attachments. Further the user can find Record(s) by entering the relevant Attachment and/or Association Remarks if any, related to the Attachment and/or Association of the Record(s). The user has a further option to exclude the entered. Attachment and/or Association Remark(s).—EXAMPLE—If the user has entered the Attachment and/or Association Remarks as “XYZ” and chooses to exclude the same, then the Control System will bring forth Find Results showing those Record(s) where “XYZ” is not there in the Attachment and/or Association Remarks. The user can further find by whether or not the Record(s) have been imported and further by Import Remarks, if any, given to the Records that were imported, with a further option to find by excluding the same in the same manner as described in case of Attachment/Association Remarks. The user can also choose to find by more than one master for a particular Criteria by using the Custom option.—EXAMPLE—the user can choose to find Record(s) for the Age Groups ‘JUNIORS’ as well as ‘SENIORS’ at a time.

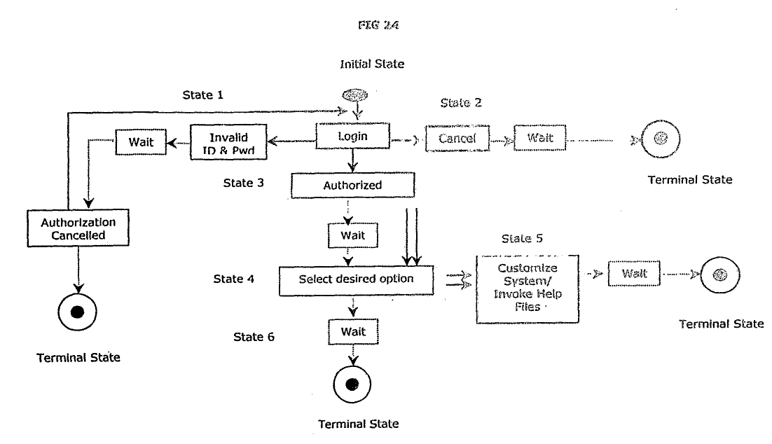

If the user chooses none of the FIND Criteria described above, then the Control System brings forth Find Results showing all the Record(s) stored in the Database(s), by all the FIND Criteria. If the user chooses one of the FIND Criteria described above, then the Control System brings forth Find Results showing Record(s) pertaining only to that FIND Criteria. If the user chooses more than one FIND Criteria described above, then the Control System brings forth Find Results showing Record(s) pertaining to the Criteria chosen by the user. The System further provides the user with a utility whereby the user can specify to the Control System to remember the FIND Criteria the next time when the user either chooses to find Record(s) or when the user logs into the System. This utility is part of the Grid Option described in FIG. 23.

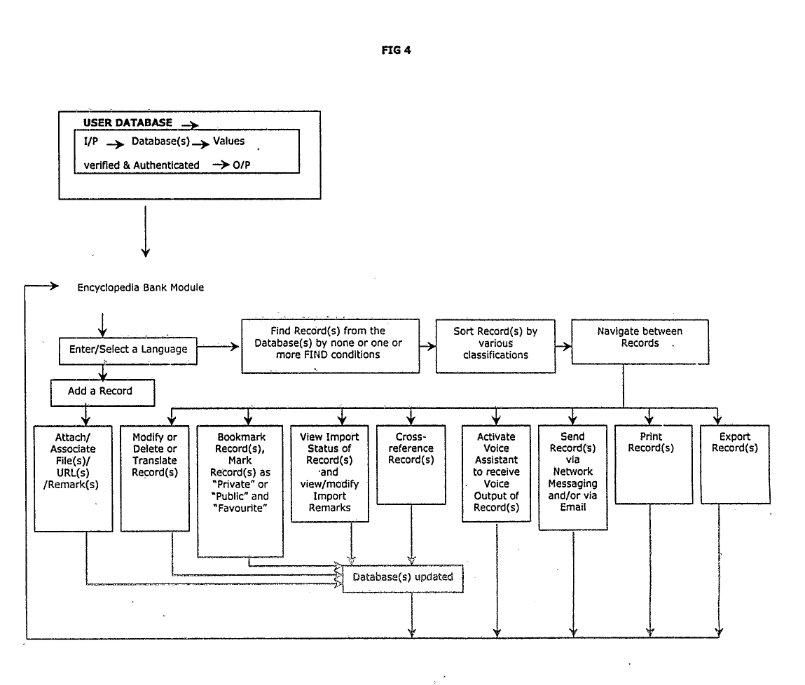

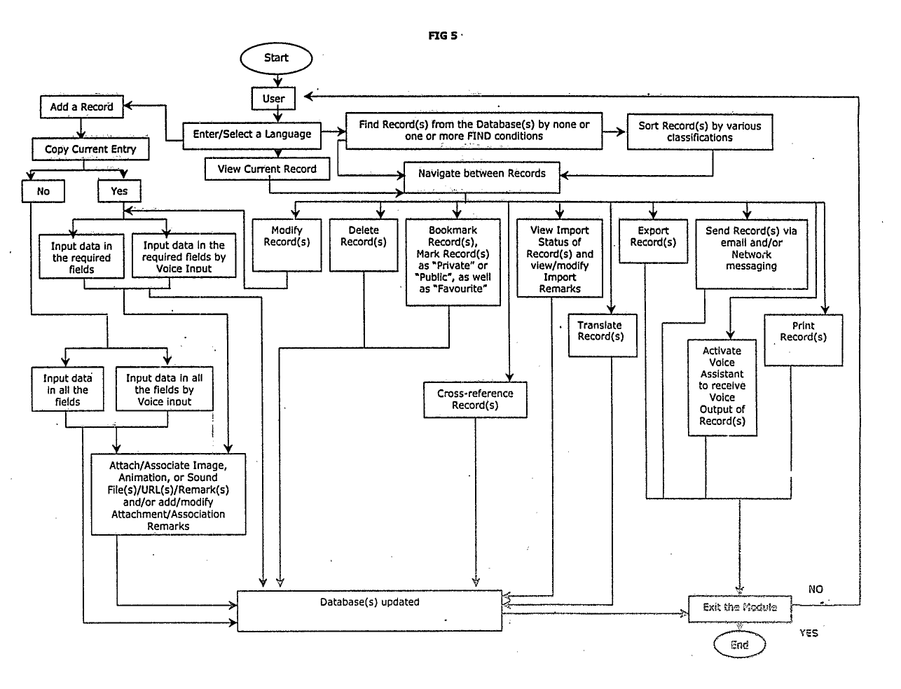

After the user has chosen to find the Record(s) by none or one or more of the FIND conditions described above, the Control System brings forth a User Interface showing a grid displaying the Record(s) brought forth according to the FIND conditions, and from where the user can Sort and Select the Record(s) in the grid. The grid shows the Records in terms of their fields like Record Id, Index Letter, Entry Title, Age Group, Language, Subject, Bookmark, and Favourite, which are displayed as columns. The user can Sort the Records, in ascending or descending order, by Classifications as well as by other criteria like Record Id, whether or not the Record(s) are Bookmarked, marked as “Public” or “Private” as well as “Favourite”, or have Attachment/Associations. The user can apply the Sort condition to-the Records currently displayed in the Find Result grid facing the user or the entire set of found Records. The user can Sort the Records, in ascending or descending order, by clicking on any column in the grid.—EXAMPLE—If the user clicks on the Subject column, then all the Records in the grid will get sorted by Subject of the Records in ascending or descending order. Further, the user can select the Record(s) in the grid and further view all the selected Record(s) through a “Selected So Far” utility. The Control System brings forth a User Interface wherein the user can further Sort and select Record(s) as well as undo this selection. The user can also view the details of the Record(s) in a separate User Interface. The user can further print the selected Record(s). The user can further make global changes to the selected Record(s), as described in FIGS. 7 and 8.

The following utilities are available to a user from the User Interface displaying the Find Result grid:
1. Sorting and Selecting-the-Records-by various Classifications and other criteria as explained above
2. Selecting single or multiple Records as well as undoing selections of the same as explained above
3. Viewing details of selected Records as explained above
4. Viewing selected Records in another User Interface through a ‘Selected so far’ utility, with a further possibility to undo the selections on the Records from this User Interface.
5. Viewing existing Bookmark Remarks of the Records as well as adding, modifying, or removing Bookmark Remarks.
6. Printing the selected Records by various Print Options.
7. Making global changes as mentioned above
8. Exporting the selected records as explained below

If the user chooses to Export the selected Record(s), the Control System brings forth a User Interface from where the user must browse for and select the desired file/folder destination on a computer system where the user wants to export. The Control System creates a Database file using the selected Record(s) at the file/folder destination on a computer system as specified by the user and notifies the user that the Record(s) were successfully exported and also displays the number of Record(s) exported. The utility(s)/functionality(s) available to the user at the time of exporting Record(s), as described in FIGS. 13 and 14; are also available in this case. After the user exports the selected Record(s), the Control System then takes the user back to the User Interface displaying the Find Result grid.

Double clicking on any Record in the Find Result grid will take the user to the concerned Record in the Module. The Find result brought forth for a particular criteria are saved until the user finds Record(s) by new criteria, or closes the User Interface displaying the Encyclopedia Bank Module. The user has the option of viewing the current Find result for a particular Find criteria through a User Interface in the Encyclopedia Bank Module.

If the user wishes to Modify an existing Record in this Module, all the utility(s)/functionality(s) available at the time of adding the Record would be available to the user and using the same, the user can make further modifications in the same if required. After modification, if the user chooses to save, the Control System saves the modifications and- updates the Database(s).

If the user wishes to Delete an existing Record in this Module, the Control System prompts the user as to whether or not the user is sure that he wishes to do so. If the user chooses to continue, the Control System deletes the Record from the Module, sends it to the Recycle Bin of the System, and updates the Database(s).

If the user chooses to Add and/or Modify Record(s) by Voice Input, the user can do so with or without a conjunction of input made by keyboard support, and/or use any other utility(s)/functionality(s) of the System, as may be supported by the System for such use, by Voice Command. The user can use all the utility(s)/functionality(s) available at the time of adding Record(s), by Voice Input.

If the user adds a Record by Voice Input and chooses to save, the Control System saves the same, generates a new Record Id, and updates the Database(s). The user can further choose to receive Voice Output by activating the Voice Assistant. A character appears which speaks out the Record through an embedded text to speech engine.

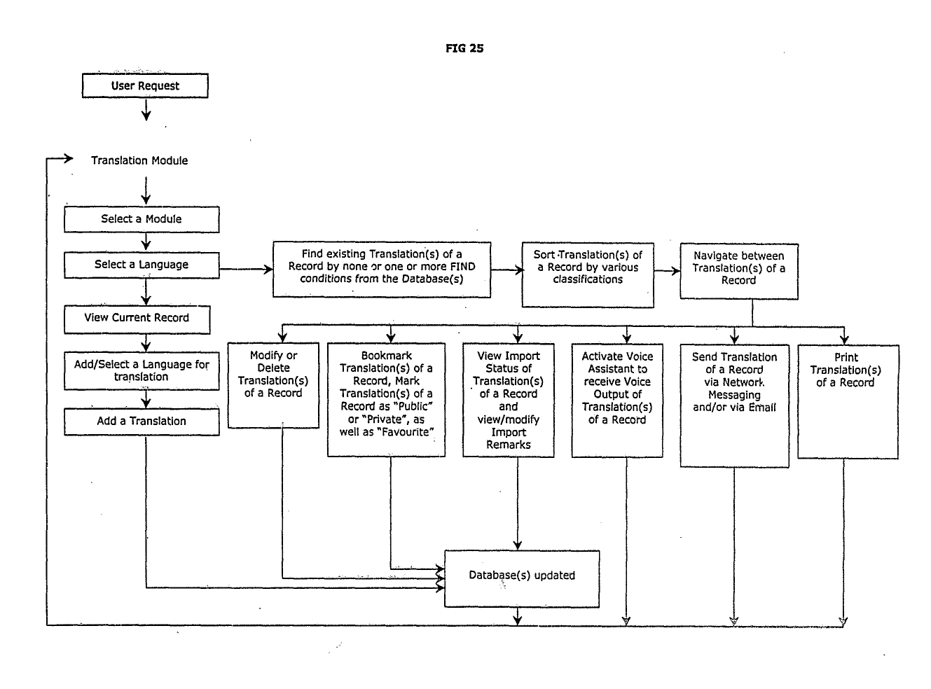

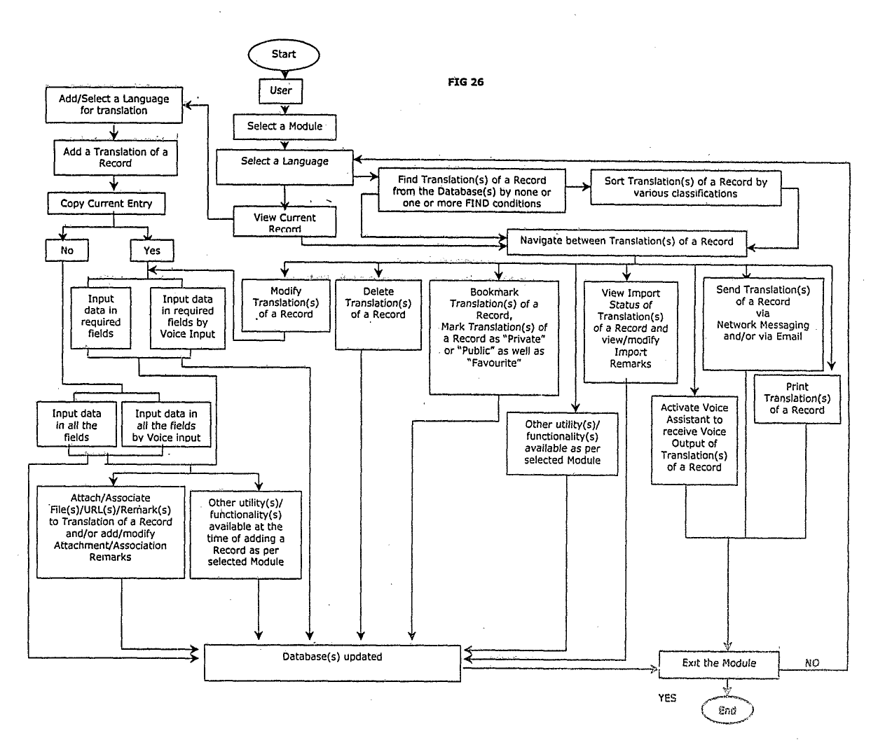

If the user chooses to Translate a Record in this Module, the user can do so by considering the Record as a parent Language Record and translate the same in any language of the user's choice. The translation is carried out in the manner described in the Translation Module in FIGS. 25 and 26. The Control System saves the Translation of the parent Language Record as a new Record, generates a new Record Id, and thus updates the Database(s).

The user can further navigate between the Records of this Module and can also choose to directly go to a Record by entering its Record Id or Entry Title in data input fields in a User Interface provided for the purpose. The user has the further option of going to the last viewed Record.—EXAMPLE—When a user enters the Encyclopedia Bank Module, the current Record displayed to the user is the latest Record that has been added to the Database(s). If the user now goes to any other Record say having Record Id as 30 and wishes to return to the Record last viewed i.e. the latest Record in this case, then the user can use the ‘Back’ option to do so. If the user thus goes to the Record last viewed by using this option, the user can also return to the Record having Record Id as 30 by using the ‘Forward’ option. While thus navigating, the user also has the option to modify such Record(s). The Control System maintains a history of the Record(s) viewed by the user till the user exits the Module. By using the ‘Back’ and ‘Forward’ options, the user can navigate between such Record(s). If the-user chooses to Cross-reference Record(s) in this Module, then the Control System brings forth a User Interface from where the user can Link Record(s), remove such Links, view the list of Record(s) linked to a Record, if any, and view the parent Record to which Record(s) have been linked. If the user chooses to Link Record(s) to the parent Record i.e. the Record currently viewed by the user in the User Interface of the Encyclopedia Bank Module, the Control System brings forth a User Interface from where the user can Find the Record(s) to be linked. The user can Find Record(s) by entering relevant keywords in a data input field provided for the purpose. The Control System searches for the keyword in the relevant data input fields for the Record(s), and brings forth the Find Results accordingly. If the user does-not enter any keywords and chooses to Find Record(s), the Control System will bring forth

Find Results showing all the Record(s) stored in the Database(s). The Record(s) found are displayed in a grid from where the user can sort and select the Record(s) and Link them to the parent Record. When a Record is thus selected, it is displayed in the User Interface of the Encyclopedia Bank Module. The user has the further option of interlinking the selected Record(s) with the parent Record.—EXAMPLE—If the user has chosen to Link a Record titled ‘SOLAR SYSTEM’, considered as the parent Record, to a Record titled ‘ASTRONOMY’, then the Record titled ‘ASTRONOMY’ will be displayed in the related links for the Record titled ‘SOLAR SYSTEM’ but not vice versa. However if the user chooses to interlink these two Records, then the Record titled ‘SOLAR SYSTEM’ will be displayed in the related links for the Record titled ‘ASTRONOMY’, and vice versa. After the user has selected the Record(s) and chosen to Link them accordingly, the Control System links these Record(s) to the parent Record, notifies the user about the same, and displays the number of Record(s) thus linked. The Control System now brings forth a User Interface displaying the list of Record(s) linked with the parent Record in a grid. If the user highlights any Record in this grid, then the Record is displayed in the User Interface of the Encyclopedia Bank Module. The User Interface further allows the user to view the parent Record in the User Interface of the Encyclopedia Bank Module. This User Interface further allows the user to select and remove links to Record(s) from the list. The Control System removes the links accordingly, notifies the user about the same, and displays the number of links thus removed. The user has a further option of removing the selected Record(s) with interlinks—EXAMPLE—If a user has chosen to remove the Link of a Record titled ‘SOLAR SYSTEM’ from the related links for the Record titled ‘ASTRONOMY’, which is considered as the parent Record, then the Link of the

Record titled ‘SOLAR SYSTEM’ gets removed accordingly. However, if the Record titled ‘SOLAR SYSTEM’ has been interlinked with the Record titled ‘ASTRONOMY’ in the manner described above, then the Record titled ‘ASTRONOMY’ would be displayed as a related link for the Record titled ‘SOLAR SYSTEM’. The user can also choose to remove this Link by selecting to remove interlinks. The Control System updates the Database(s) whenever Record(s) are linked or such links are removed.

If the user chooses to Bookmark a Record in this Module, then the Control System brings forth a User Interface from where the user must enter some Bookmark Remarks in order to Bookmark the Record. The user can also view the earlier Bookmark Remarks, if any, and can further modify the same. The Control System bookmarks the Record accordingly. From the User Interface, the user can also remove the flag of Bookmark from the Record. The Control System updates the Database(s) whenever a Record is Bookmarked or the Bookmark flag is removed from it.

If the user chooses to mark a Record in this Module as “Public” or “Private” and/or “Favourite”, the Control System flags the Record accordingly. Further when a Record is marked as “Private” by a user who has logged in to the System, the Record will not be visible to other users who log into the same System at any other point of time. The user can also choose to remove the flag of “Public” or “Private” and/or “Favourite”. The Control System updates the Database(s) whenever a Record is marked as “Public” or “Private” and/or “Favourite”, or whenever these flags are removed from the Record.

If the user chooses to print Record(s) in this Module, the Control System brings forth a print preview of the same, from which the user can print further. The user can further choose to print Record(s) found by a FIND condition as specified by the user, in the same manner as that of the current Record. The Printing utility further allows the Print reports to be Exported to various destinations in various file formats.

A further utility allows the user to send the Record via Email and/or Network Messaging.

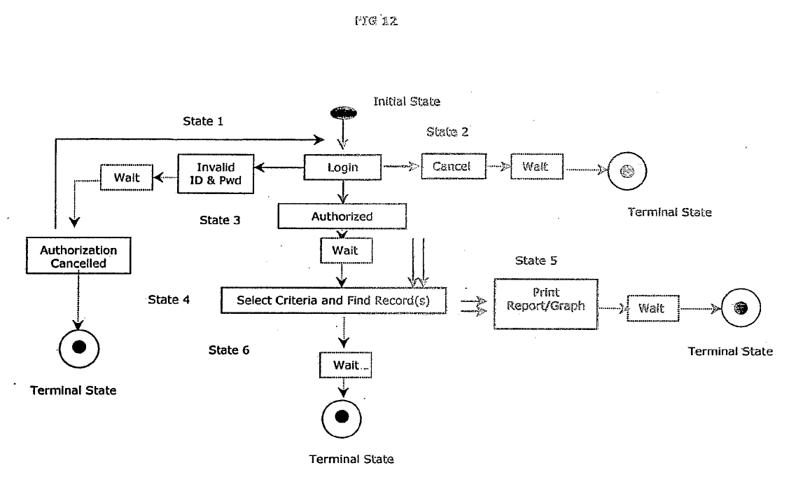

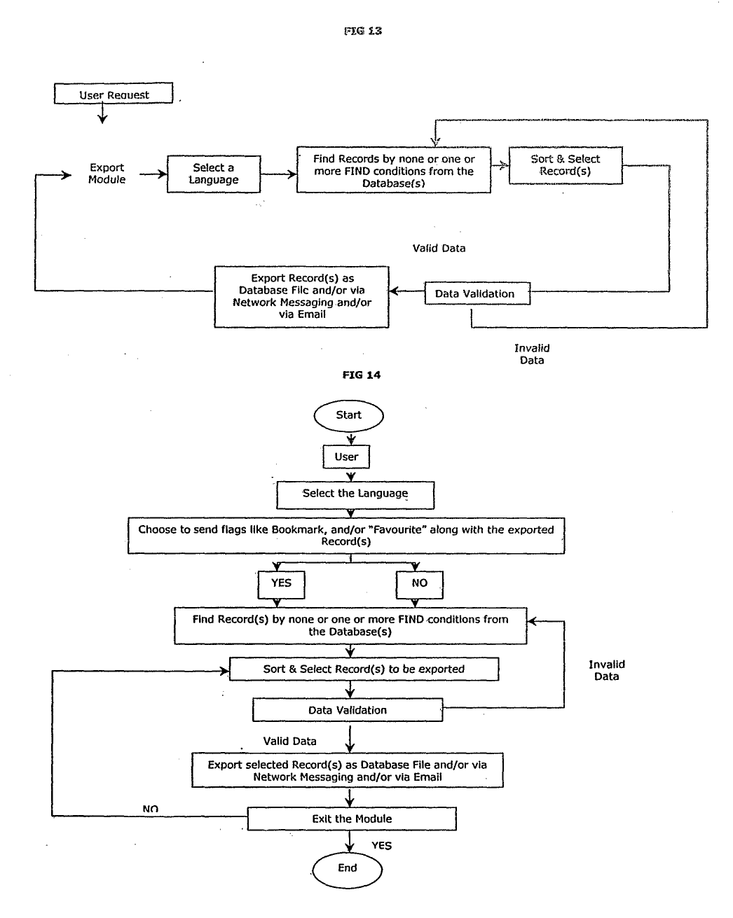

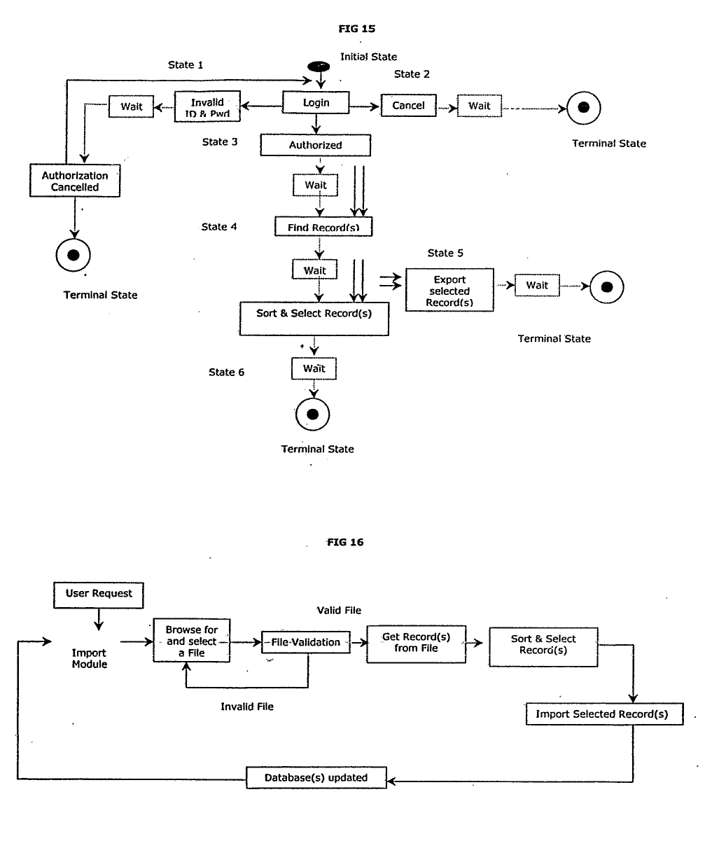

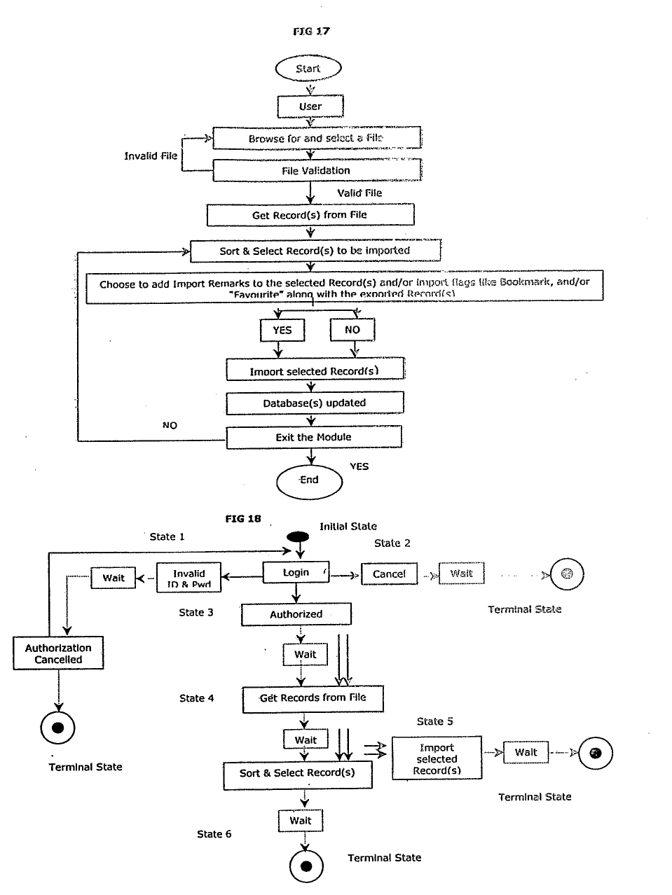

If the user chooses to view Import Status of a Record in this Module, the Control System will bring forth a User Interface showing whether or not the Record has been imported from a Database File in the manner described in the Import Module in FIGS. 16 and 17. The user can further view and modify the Import Remarks associated with the Record in a data input field provided for the purpose. The user can further choose to remove the Import Remarks. The Control System updates the Database(s) whenever the Import Remarks are added, modified, or removed.

If the user chooses to Export an existing Record in this Module, the Control System brings forth a User Interface from where the user must browse for and select the desired file/folder destination on a computer system where the user wants to export. The Control System creates a Database file using the Record at the file/folder destination on a computer system as specified by the user and notifies the user that the Record was successfully exported and also displays the number of Record exported. The utility(s)/functionality(s) available to the user at the time of exporting Record(s), as described in FIGS. 13 and 14, are also available in this case.

The Module also accepts data built by another user (Exporting user) of the System, and which may be further manipulated by the user (Importing user) to suit the user's requirements. (EXAMPLE—the Exporting user may have classified an article on the solar system under the subject SCIENCE, but the Importing user would like to classify the same under the subject ASTRONOMY) Any data entered or imported into the Encyclopedia Bank Module is further used as part of the functions of the other Modules of the System.

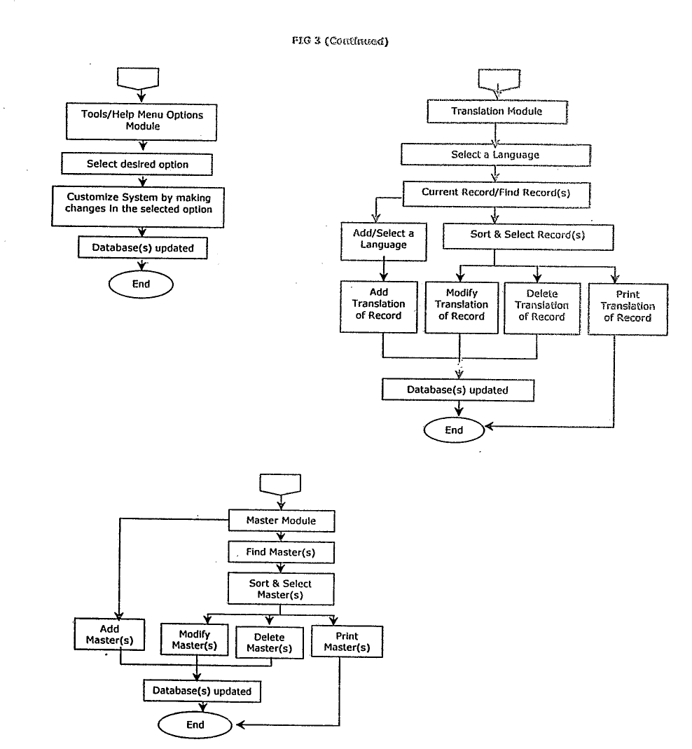

FIG. 6 describes the System State Transition of the Encyclopedia Bank Module explaining that the Module is based on different States. The System receives events from the user(s), and each event causes the transition from one state to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIG. 7 is the diagram of the System Function of Global Changes Module of the present invention. The architecture of this Module comprises the following major functions, which allow a user to make global changes to the Records stored in the Database(s) like globally Modifying part(s) of Records, globally Deleting Records, globally Bookmarking Records, globally marking Records as. “Public” or “Private”, globally marking Records as “Favourite”, globally Associating additional information in the form of File(s)/URL(s)/Remark(s) to Records, globally Attaching a File such as an Image, Animation, or a Sound file to Records, or globally Translating Records with the help of the User Interface.

The Module allows a user to:

Select a Language
Find existing Records from the Database(s) by none or one or more FIND conditions
Sort and Select Record(s)
Globally Modify part(s) of Record(s), globally Delete Record(s), globally
Bookmark Record(s), globally mark Record(s) as “Public” or “Private”, globally mark Record(s) as “Favourite”, globally Associate additional information in the form of File(s)/URL(s)/Remark(s) to Record(s), globally Attach a File such as an Image, Animation, or a Sound file to Record(s), or globally Translate the selected Record(s).

FIG. 8 describes the System Operation of the Global Changes Module, explaining that the Module is based on user actions.

When the user enters this Module, the Control System brings forth a User Interface from where the user must first select the Language in which the Records are to be brought forth and then find Record(s) from the Database(s) by none or one or more FIND conditions for making global changes. The FIND conditions in this case are the same as the ones described in FIG. 5. The Control System brings forth a User Interface, displaying the Find Results in a grid, and from where the user can Sort and Select the Record(s) for making global changes. The User Interface provides the user with the same utility(s)/functionality(s) applicable to Record(s) in a Find Result grid as described in FIG. 5. Double clicking on any Record in the grid will take the user to the Record in the Module. The user can choose to either globally Modify, globally Delete, globally Bookmark, globally mark as “Public” or “Private”, globally mark as “Favourite”, globally Associate additional information in the form of File(s)/URL(s)/Remark(s), globally Attach a File such as an Image, Animation, or a Sound file, or globally Translate the selected Record(s).

If the user chooses to globally Modify selected Record(s), the Control System brings forth a User Interface from where the user can select the desired part or data input field of the Record(s) that the user wishes to Modify, enter/select to find that which is to be replaced in that selected data input field, and further enter/select to Replace that which is thus found, in specific data input fields provided for the purpose.—EXAMPLE—If the user selects a data input field like Age Group, for the selected Record(s), the user can select to find the Age Group say ‘JUNIORS’ and can enter or select-to Replace it with the Age Group ‘SENIORS’. The Control System searches the Age Group field of the selected Record(s) for ‘JUNIORS’ and replaces it with ‘SENIORS’. Further, if the user selects a data input field like Remarks, then the user must enter some text which the user wishes to find to be replaced in the Remarks field and then enter the text that will replace this found text.—EXAMPLE—If the user enters ‘ABC’ to be found to be replaced and then enters ‘XYZ’ as the text to Replace ‘ABC’, the Control System will search the Remarks field of the selected Record(s) for all occurrences of ‘ABC’ and Replace it with ‘XYZ’. After entering or selecting to find and Replace, the Control System prompts the user as to whether or not the user wants to do the same. If the user continues,the Control System modifies the selected Record(s) accordingly, notifies the user that the selected Record(s) have been modified, and displays the number of Record(s) modified. The Control System updates the Database(s) whenever the Record(s) are modified. If the user chooses to globally Delete the selected Record(s), the Control System prompts the user as to whether or not the user wishes to Delete the selected Record(s). If the user continues, the Control System deletes the selected

Record(s) from the grid, notifies the user that the Record(s) have been deleted, and also displays the number of Record(s) deleted. The Control System sends the deleted Record(s) to the Recycle Bin of the System and updates the Database(s) accordingly.

If the user chooses to globally Bookmark the selected Record(s), the Control System prompts the user as to whether or not the user wishes to do the same. If the user continues, the Control System brings forth a User Interface where the user must enter some Bookmark Remarks in order to Bookmark the selected Record(s). After the user enters the Bookmark Remarks and saves the same, the Control System prompts the user as to whether the user wishes to overwrite or append to the existing Bookmark Remarks, If any, of the selected Record(s) in case such Record(s) have been bookmarked earlier. After the user selects either to overwrite or append to the existing Bookmark Remarks, the Control System bookmarks the Record(s) accordingly, notifies the user that the Record(s) have been bookmarked, and displays the number of Record(s) bookmarked. The user can view the existing Bookmark Remarks of all Record(s) in the Find Result grid, in case such Record(s) have been bookmarked earlier. The user can further remove the Bookmark flag of the selected Record(s) in case such Record(s) have been bookmarked earlier. The Control System updates the Database(s) whenever the Record(s) are bookmarked, or the existing Bookmark Remarks of Record(s) are modified, or whenever the Bookmark flag is removed from the Record(s) which have been bookmarked earlier.

If the user chooses to globally mark the selected Record(s) as “Public” or “Private”, the Control System brings forth a User Interface where the user must select either to mark the Record(s) as “Public” or “Private”. After the user selects either one of these two options, the Control System prompts the user as to whether or not the user wishes to thus mark the selected Record(s). If the user continues, then the Control System marks the selected Record(s) as “Public” or “Private” as may be specified by the user, notifies the user that the Record(s) have been thus marked, and displays the number of Record(s) thus marked. The user can also remove the “Public” and “Private” flags of the selected Record(s) in case such Record(s) have been marked earlier as “Public” or “Private”. The Control System updates the Database(s) whenever the Record(s) are marked as “Public” or “Private” or whenever the flags of “Public” or “Private” are removed from Record(s) which have been marked earlier as “Public” or “Private”.

If the user chooses to globally mark the selected Record(s) as “Favourite”, the Control System prompts the user as to whether or not the user wishes to thus mark the selected Record(s). If the user continues, then the Control System marks the selected Record(s) as “Favourite”, notifies the user that the Record(s) have been thus marked, and displays the number of Record(s) thus marked. The user can also remove the “Favourite” flag of the selected Record(s) in case such Record(s) have been marked earlier as “Favourite”. The Control System updates the Database(s) whenever the Record(s) are marked as “Favourite” or whenever the flag of “Favourite” is removed from Record(s) which have been marked earlier as “Favourite”.

If the user chooses to globally Associate File(s)/URL(s)/Remark(s) to the selected Record(s), the Control System prompts the user as to whether or not the user wants to do the same. If the user continues, the Control System brings forth a User Interface from where the user can Associate File(s)/URL(s)/Remark(s), and also add Remarks about such associations. In case the user wants to Associate File(s) with the Record(s), the user can browse for and select the File(s), from a computer system. In case the user wants to

Associate URL(s) or Remark(s), the user must enter the same into a data input field provided for the purpose. The user can further enter Remarks about each Association in a data input field provided for the purpose. From the User Interface, the user can also open and view the Associated File or URL and further can delete the Association(s) that the user might have given to the selected Record(s) at this time. If the user chooses to save the Association(s), then the Control System Associates the File(s)/URL(s)/Remark(s) to the selected Record(s), notifies the user about the same, and displays the number of Record(s) to which either File(s)/URL(s)/Remark(s) have been associated. The user can also delete all Association(s) of the-selected Record(s) in case such Record(s) have been associated- with File(s)/URL(s)/Remark(s) earlier. The Control System updates the Database(s) whenever File(s)/URL(s)/Remark(s) are associated and/or Association Remarks are added to the selected Record(s) or whenever any previous Associations are deleted-from-the selected Record(s).

If the user chooses to globally Attach a File to the selected Record(s), the Control System prompts the user as to whether or not the user wants to do the same, also notifying the user that the Attachment made by the user at this time will replace the earlier Attachment, if any, of the selected Record(s). If the user continues, the Control System brings forth a User Interface from where the user can Attach a File, and add Remarks about this Attachment. In order to Attach a File with the Record(s), the user must browse for and select the File, from a computer system. The user can further enter Remarks about the Attachment in a data input field provided for the purpose. From the User Interface, the user can also open and view the Attached File. If the user chooses to save the Attachment, then the Control System prompts the user to choose whether to Attach the File to all of the selected Record(s) or only to those selected Record(s) which do not have any File Attachment. Depending on the user's choice, the Control System Attaches the File to the selected Record(s) accordingly, notifies the user about the same, and displays the number of Record(s) to which the File has been attached. The user can also delete the Attachment(s) of the selected Record(s) in case such Record(s) have been attached with a File earlier. The Control System updates the Database(s) whenever a File is attached with or without adding Attachment Remarks, to the selected Record(s) or whenever any previous Attachment is deleted from the selected Record(s).

If the user chooses to globally Translate the selected Record(s), the Control System brings forth a User Interface from where the user must select the part(s) of the selected Record(s) to be translated and then enter/select the Language to do the same. The user must further-enter the translation(s) of the selected part(s) in the Language entered or selected, in data input fields provided for the purpose. After entering the translation, the Control System prompts the user as to whether or not the user wants to save the same. If the user continues, the Control System translates the selected Record(s) accordingly, notifies the user that the selected Record(s) have been translated, and displays the number of Record(s) translated. The Control System updates the Database(s) whenever the Record(s) are globally translated.

When the user closes the User Interface from where the user can make global changes as described above, the Control System gets notified and the user comes out from the Module.

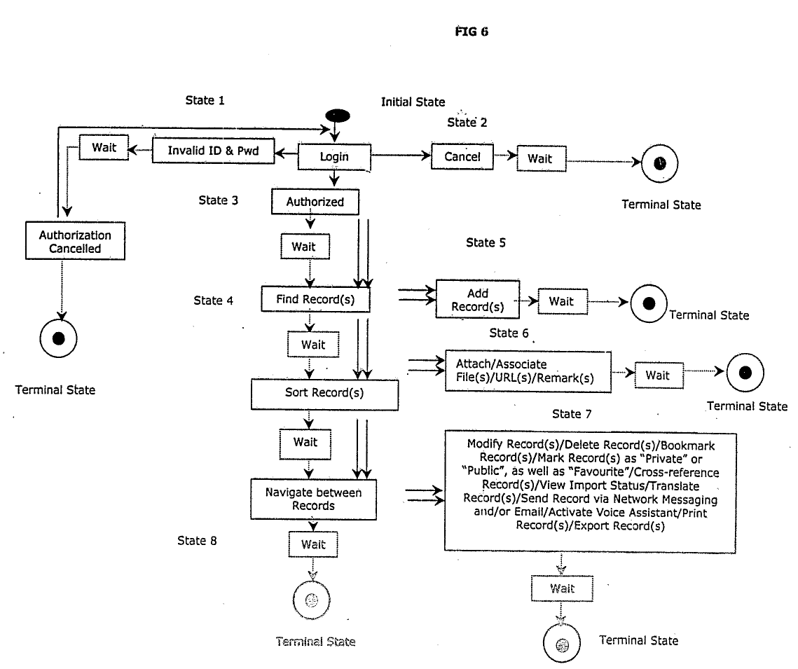

FIG. 9 describes the System State Transition of the Global Changes Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 10 to 12 explain the System Function, System Operation, and System State Transition respectively of the Reports Module which allows a user to obtain Reports and/or Graphs.

FIG. 10 is the diagram of the System Function of Reports Module of the present invention. The architecture of this Module comprises the following major functions, which allow a user to obtain Reports and/or Graphs with the help of the User Interface.

The Module allows a user to:

Select a Language
Select a Report type
Select Criteria
Print Report/Graph with or without the details of the selected Criteria by
using Record(s) found from the Database(s) by none or one or more FIND conditions, pertaining to the selected Report, in the selected Language

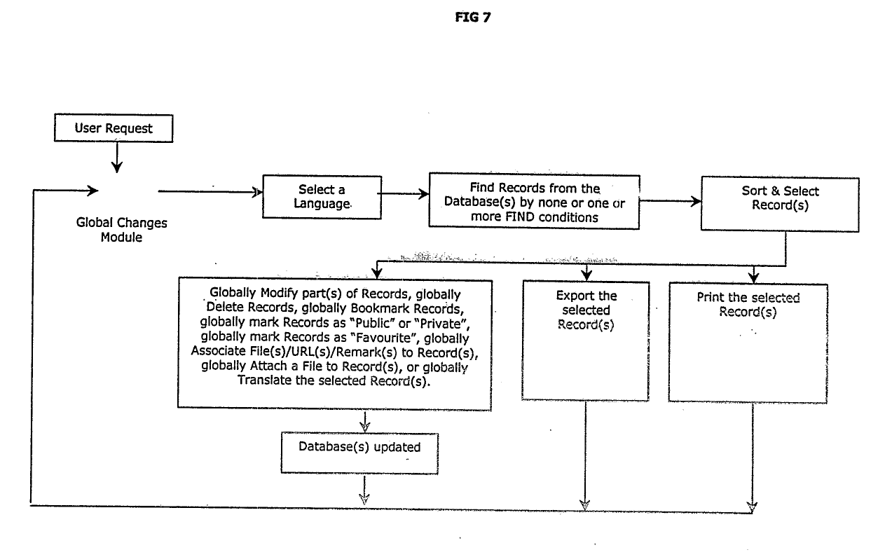

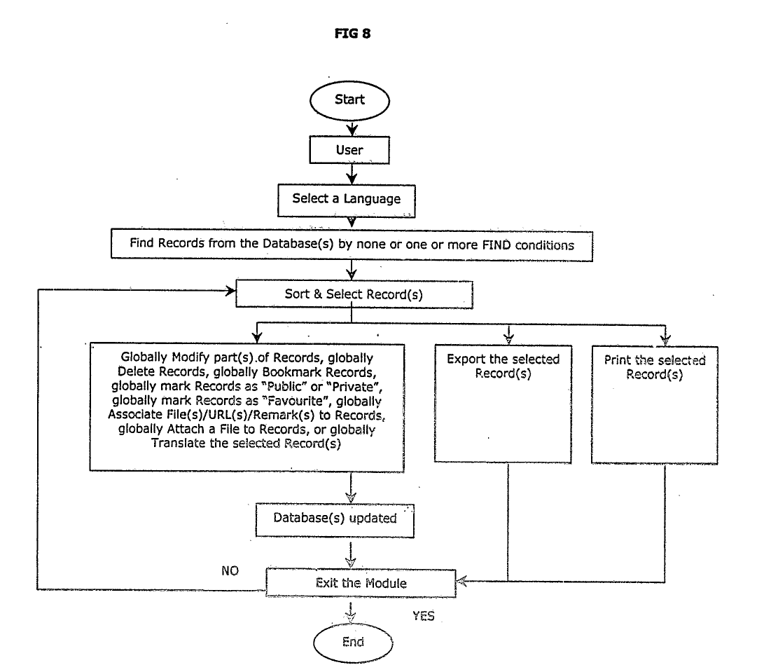

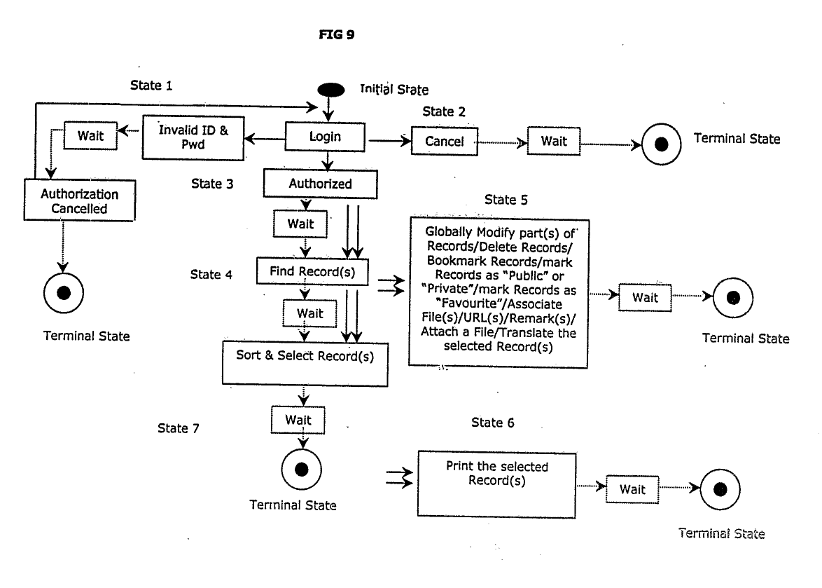

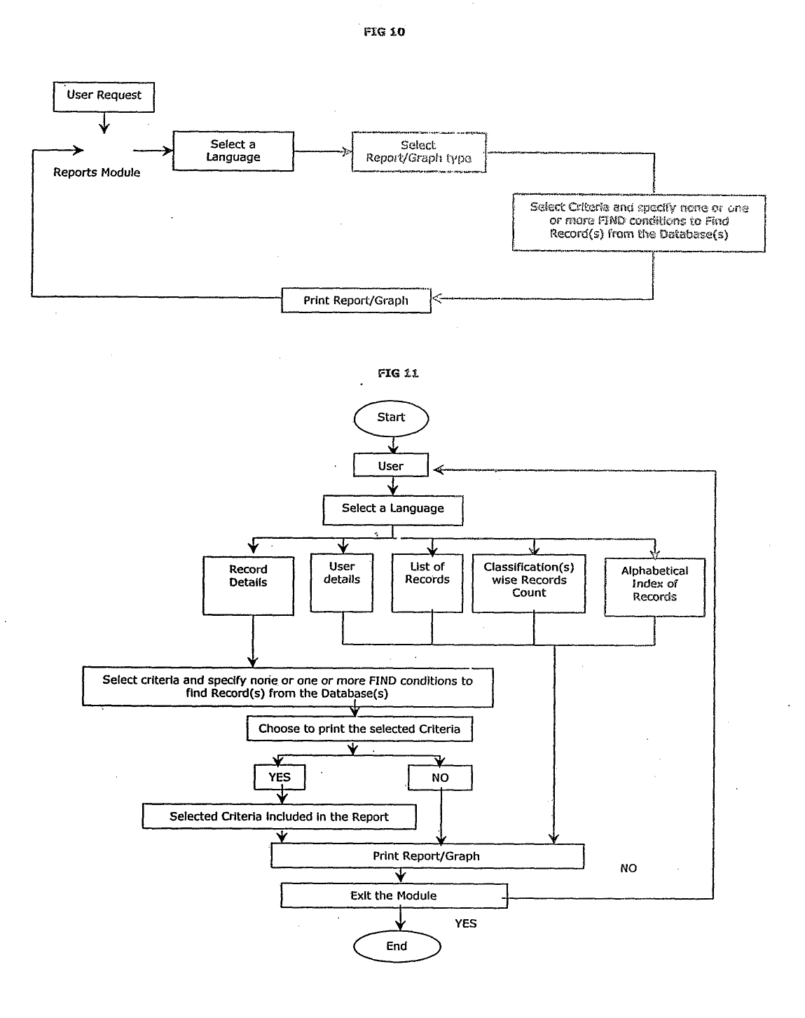

FIG. 11 describes the System Operation of Reports Module, explaining that the Module is based on user actions.

When the user enters this Module, the Control System brings forth a User Interface from where the user must first select the Language in which the user wishes to obtain the Report. The User Interface displays a list of all the available types of Reports along with a brief description about each Report. The Reports Module allows the user to obtain the following Reports like:
List of Records
Alphabetical Index of Record(s)
Count of Records by Classification(s)
User Details
Record details report

The user then selects one of these Report types for printing. The Control System, depending on the type of Report selected, either brings forth a print preview of the Report from where the user can directly print the Report or brings forth a User Interface wherein the user must enter/select some Criteria beforehand and then the Control System brings forth the print preview of the Report by using Record(s) found from the Database(s) by the Criteria specified by the user. The user comes out of the Module by closing either the print preview or the User Interface mentioned.

FIG. 12 describes the System State Transition of the Reports Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 13 to 15 explain the System Function, System Operation and System State Transition respectively of the Export Module which provides the user with the utility of Exporting Records (by means of a Database file created by the System) stored in the Database(s), by finding the same from the Database(s) based on none or one or more FIND conditions,

FIG. 13 is the diagram of the System Function of Export Module of the present invention. The architecture of this Module comprises of the following major functions, which allow a user to Export Record(s) stored in the Database(s), with the help of the User Interface.

The Module allows a user to:

Select the Language
Find existing Record(s) from the Database(s) by none or one or more FIND conditions
Sort and Select Record(s)
Validate Data
Export selected Record(s) as Database File and/or via Email and/or Network Messaging.

FIG. 14 describes the System Operation of Export Module, explaining that the Module is based on user actions.

When the user enters this Module, the Control System brings forth a User Interface from where the user must select the Language in which the Record(s) to be exported are to be brought forth. The User Interface further allows the user to choose whether or not to send flags like Bookmark, and/or “Favourite”, if any, along with the Record(s) to be exported.—EXAMPLE—If the exporting user is exporting Record(s) which have been Bookmarked, that user has an option of selecting whether or not to send the Bookmarks and associated Bookmark Remarks along with such Record(s) to be exported. If the exporting user selects to send the Bookmarks and associated Bookmark Remarks, then the importing user is allowed to see that the Records(s) have been bookmarked and can further view and modify the Bookmark Remarks associated with the bookmarked Record(s). Else, the importing user cannot see that the Records(s) have been bookmarked. The same applies in case the user wishes to send the ‘Favourite’ flag. The exporting user can choose to send either particular flag(s), all flags, or none of the flags with the Record(s) to be exported. The user can also undo selections of the same. The flags that are chosen to be sent along with the Record(s) to be exported are those set by the user who has logged in to the System. After the user has chosen whether or not to send the desired flags, the. Control System brings forth a User Interface from where the user can find Record(s) to be exported, from the Database(s) by none or one or more FIND conditions. The FIND conditions in this case are same as the ones described in FIG. 5. The Control System brings forth a User Interface, displaying the Find Results in a grid, and from where the user can Sort and Select the Record(s) to be exported. The Sort and Select, including ‘Selected So Far’, functionalities in this case are same as the ones described in FIG. 5. The User interface provides the user with the same utility(s)/functionality(s) applicable to Record(s) in a Find Result grid as described in FIG. 5. The user can also view the details of the selected Record(s) or those of the entire set of found Record(s). If the user chooses to Export the selected Record(s), the Control System performs a Data Validation in that it checks whether the data that the user wishes to be exported, is exportable or not. If the selected Record(s) meet the Criteria of the Data Validation, the Control System allows these Record(s) to be exported. Else, the Control System notifies the user that the Record(s) cannot be exported. After Data Validation, the Control System brings forth a User Interface from where the user must browse for and select the appropriate file/folder destination on a computer system where the user wants to Export. After this selection, the user can Export the selected Record(s) as a Database File and/or via Email and/or Network Messaging. The Control System creates a Database file using the selected Record(s) at the file/folder destination on a computer system as specified by the user and notifies the user that the selected Record(s) were successfully exported and also displays the number of Record(s) exported. The Control System adds the User Details of the exporting user to the Record(s) in the Database file. These User Details can be viewed and further modified by the importing user through the User Interface showing-the import Remarks, which is described in FIG. 17. After this, the Control System takes the user back to the User Interface from where the user can further Sort, Select, and Export Record(s). If the user closes this User Interface, the Control System gets notified and the user comes out from the Module.

FIG. 15 describes the System State Transition of the Export Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 16 to 18 explain the System Function, System Operation and System State Transition, respectively, of the Import Module which provides the user with the utility of Importing Records from a Database file that may have been created by other user(s) of this System, with the utility of appending to the data already stored by the user in the Database(s).

FIG. 16 is the diagram of the System Function of Import Module of the present invention. The architecture of this Module comprises the following major functions, which allow a user to Import Record(s) from a Database file that may have been created by other user(s) of this System, with the help of the User Interface.

The Module allows a user to:

Browse for and select a Database file
Validate the file
Get Record(s)
Sort and Select Record(s)
Import Record(s)

FIG. 17 describes the System Operation of Import Module, explaining that the Module is based on user actions.

When the user enters this Module, the Control System brings forth a User Interface from where the user must browse for and select the appropriate Database file on a computer system from which the user wants to Import Record(s). After this selection, the Control System verifies whether the file selected by the user is a valid Database file or not. If the file selected by the user is not a valid Database file, then the Control System notifies the user that the file is invalid and hence can't be imported. Else, the Control System brings forth a User Interface displaying all the Record(s) in the Database file in a grid, and from where the user can further Sort and Select the Record(s) to be imported. The Sort and Select functionalities are same as the ones described in FIG. 5. The user can select to import, the Record(s) which the user has highlighted, the entire set of Record(s) displayed in the grid facing the user, or the entire set of Record(s) in the Database file. The user can also undo these selections. The user can further view the selected Record(s) through a ‘Selected So Far’ utility, wherein the Control System brings forth a User Interface from where the user can view the selected Record(s) as well as Sort and make further selections or undo selections of the same. If the user chooses to import the selected Record(s), the Control System brings forth a User Interface from where the user can add/modify Import Remarks, and choose whether or not to import flags like Bookmark (and associated Bookmark Remarks) and/or “Favourite” along with the Record(s). The flags have been set by the exporting user who has created the Database file by the export activity described in FIGS. 13 and 14. The data input field for Import Remarks in the User Interface, shows by default, the name of the exporting user and the date on which the Database file, which the user has selected to Import Record(s), was created. This feature helps the user to keep track of the Records received from a particular exporting user, for the purpose of future reference. The user can further modify these Import Remarks and add more Import Remarks as desired. These Import Remarks can be seen and further modified through the Encyclopedia Bank Module described in FIGS. 4 and 5, into which the Record(s) are imported. The user can also choose to import the selected Record(s) without adding any Import Remarks. After the user has chosen to import the selected Record(s), the Control System appends the Record(s) to the Database(s) according to the Module to which the Record(s) belong. After importing, the Control System updates the Database(s) and notifies the user that the selected Record(s) were successfully imported and also displays the number of Record(s) imported. After this, the Control System takes the user back to the User Interface from where the user can further Sort and Select Record(s) to be imported. If the user closes this User Interface, the Control System gets notified and the user comes out from the Module.

FIG. 18 describes the System State Transition of the Import Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

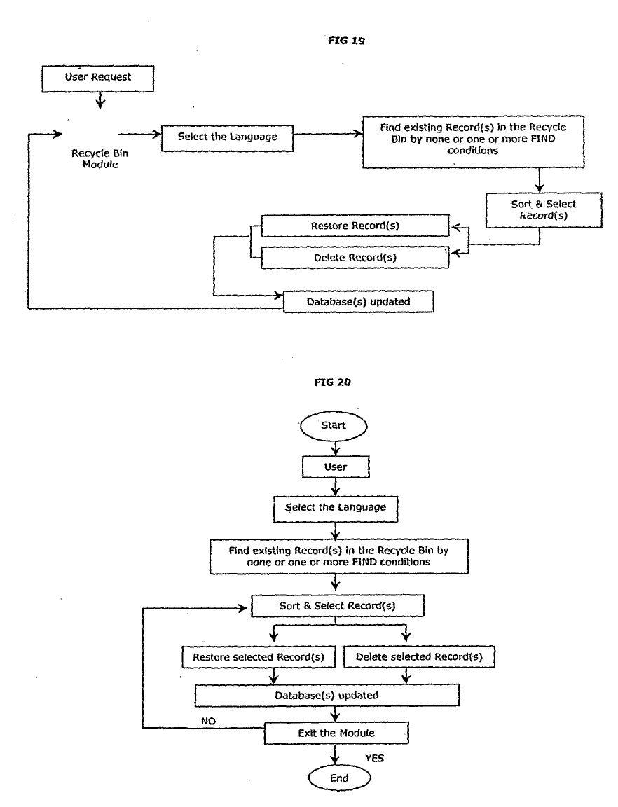

FIGS. 19 to 21 explain the System Function, System Operation and System State Transition respectively, of the Recycle Bin Module which allows the user to Restore or Permanently Delete Record(s), which may have been deleted by the user.

FIG. 19 is the diagram of the System Function of Recycle Bin Module of the present invention. The architecture of this Module comprises of the following major functions, which allow a user to Restore/Permanently Delete Record(s) with the help of the User Interface.

The Module allows a user to:

Select the Language
Find existing Record(s) in the Recycle Bin of the System, by none or one or more FIND conditions
Sort and Select Record(s)
Restore/permanently Delete selected Record(s)

FIG. 20 describes the System Operation of the Recycle Bin Module of the present invention explaining that the Module is based on user actions.

When the user first enters this Module, the Control System brings forth a User Interface from where the user must select the Language in which the Record(s) to be Restored or Permanently Deleted are to be brought forth. The User Interface also allows the user to find the Record(s) that have been deleted earlier and are lying in the Recycle Bin of the System, by none or one or more FIND conditions. The FIND conditions in this case are the same as the ones described in FIG. 5. The Control System brings forth a User Interface displaying the Find Results showing the Record(s) which have been deleted by the user, in a grid, and from where the user can further Sort and Select the Record(s) to be Restored or permanently Deleted. The Sort and Select, including ‘Selected So Far’, functionalities in this case are same as the ones described in FIG. 5. The user can also view the details of the selected Record(s) or those of the entire set of found Record(s). The user can also print the selected Record(s). After the user selects the Record(s), the user can choose to either Restore or permanently Delete the Record(s). In both cases, the Control System prompts the user as to whether or not the user wants to Restore or permanently Delete the selected Record(s). If the user chooses to Restore the selected Record(s), the Control System takes the selected Record(s) out of the Recycle Bin and restores them back to their respective Module with their original Record Id(s). If the user chooses to permanently Delete the selected Record(s), the Control System deletes the selected Record(s) from the Recycle Bin and thus permanently removes the Record(s) from the Database(s).

Whenever Record(s) are Restored or Deleted, the Control System updates the Database(s) and notifies the user that the selected Record(s) were successfully Restored or Deleted and also displays the number of Record(s) Restored or Deleted. After this, the Control System takes the user back to the User Interface from where the user can further Sort and Select Record(s) to be Restored or Deleted. This User Interface further allows the user to print and/or Export the selected Record(s) displayed in the grid in the same manner as described in FIG. 5. If the user closes this User Interface, the Control System gets notified and the user comes out from the Module.

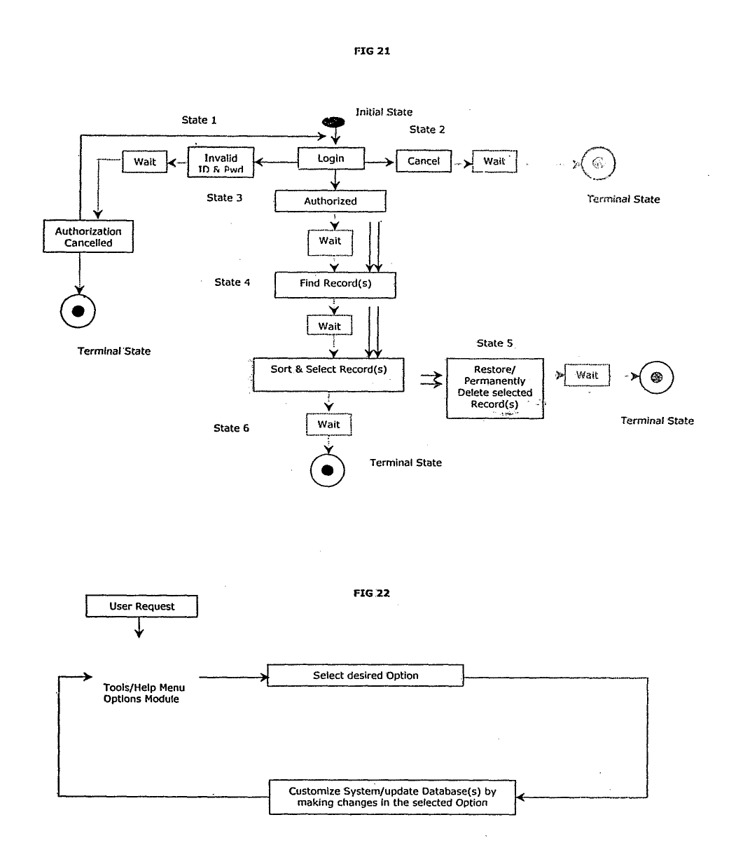

FIG. 21 describes the System State Transition of the Recycle Bin Module of the System explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

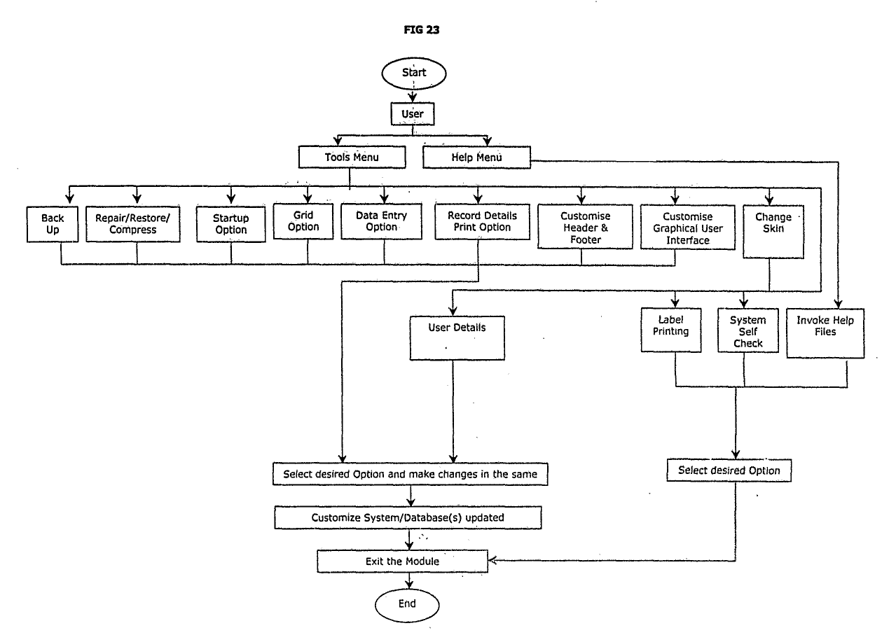

FIGS. 22 to 24 explain the System-Function, System Operation and System State Transition respectively, of the Tools/Help Menu Options Module comprising of maintenance Tools such as Back Up, Repair, Restore, Compression of the entire Database(s) and system Self Check. There are other tools such as Start Up Option, Grid Option, Data Entry Option, Label Printing, Record Details Print Option, Customize Header and Footer, Customize Graphical User Interface, Change Skin, User Details, and Help.

FIG. 22 is the diagram of the System Function of Tools/Help Menu Options Module of the present invention. The architecture of this Module comprises of the following major functions, which allow a user to select any option for Customization including maintenance of the System and updating of Database(s).

The Module allows a user to:

Select any option
Customize the System/Update Database(s) by making changes in the selected option.

FIG. 23 describes the System Operation of the Tools/Help Menu Options Module, explaining that the Module is based on user actions. Through this Module, the user can select any of the options mentioned below for customization and maintenance of the System.

The Tools/Help Menu Options Module, through the User Interface, retrieves and brings forth the-following-utilities which the user can select:
Back Up—This utility allows the user to back up the Database(s). If the user selects this utility, the Control System brings forth a User Interface from where the user must browse for and select the appropriate file/folder destination on the user's computer system, where the user wants to take the backup. The Control System backs up the entire Database(s) and creates a backup at the selected file/folder destination.
Restore—This utility allows the user to restore the Database(s) from a backup taken by the user by using the Back Up utility. If the user selects this utility, the Control System brings forth a User Interface from where the user must browse for and select the appropriate file/folder destination on the user's computer system, where the user has taken the backup. The Control System restores the Database(s) with the backup accordingly.
Repair and Compress—This utility allows the user to repair and compress the Database(s).
System Self Check—This utility allows the user to initiate a System Self Check. If the user selects this utility, the Control System gets notified and initiates a System Self Check. The Control System notifies the user whether the System Self Check has completed successfully or not, and further generates a Report displaying the tasks performed during the System Self Check.
Start Up Option—This utility allows the user to set conditions like the Login User Interface and Quick Start User Interface to appear each time the System is initiated. If the user selects this utility, the Control System allows. the user to select either or both the Login and the Quick Start User Interfaces to appear each time the System is initiated. The Control System updates the Database(s) in this case.
Grid Option—This utility allows the user to enter the number of Record(s) to be displayed in a Find Result grid at a time, facing the user. EXAMPLE—If the user enters 24, then 24 Record(s) will be displayed in any Find Result grid at a time, facing the user. This utility further allows the user to choose whether or not the Control System should remember the current FIND criteria entered and/or selected by the user when the user chooses to find Record(s) from the Database(s). The Control System updates the Database(s) In this case.
Data Entry Option—This utility allows the user to enable/disable the “Copy Current Entry” functionality during data input, as well as allowing further customization of the same. The “Copy Current Entry” functionality is described in FIG. 5. If the user selects this utility, the Control System brings forth a User Interface, from where the user must first select whether to have “Copy Current Entry” functionality during data input or not, as well as select the data input fields to be copied using this functionality. The Control System updates the Database(s) in this case.
Label Printing—This utility allows the user to print user information labels.
Record Details Print Option—This utility allows the user to customize the Criteria for printing Details of a Record. If the user selects this utility, the user must first select the Language. The Control System brings forth a User Interface from where the user can select the part(s) of a Record that are to be printed. The user can also undo all of these selections. The Control System updates the Database(s) in this case.
Customize Header and Footer—This utility allows the user to customize the Header and Footer for the Printed outputs. If the user selects this utility, the Control System brings forth a User Interface from where the user can enter the appropriate Header and Footer details which will appear in all the Reports. The Control System updates the Database(s) in this case.
Customize Graphical User Interface—This utility allows the user to change the Labels that appear on the User Interface. The Control System updates the Database(s) in this case.
Change Skin—This utility allows the user to select the “skins” for the User Interface. If the user selects this utility, the Control System brings forth a User Interface from where the user can browse for and select the desired “skin” file. The user can also set a “skin” file as the default “skin”. The user can also undo these selections. The Control System—updates the Database(s) in this case.
User Details—This utility allows the user to enter or modify the user details like User Name and Password. The user can also create Sub users through this option. The Control System updates the Database(s) accordingly.
Help—This utility allows the user to invoke the Help files, which provide Help on how best to use the System.

After selecting any of the options mentioned above and customising or using the same, the user comes out of the Module.

FIG. 24 describes the System State Transition of the Tools/Help Menu Options Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State to occur each of which has its own Terminal State. A transition shown with a dotted line indicates that it is leaving from one State and entering another State.

FIGS. 25 to 27 explain the System Function, System Operation and System State Transition respectively of the Translation Module of the present invention. The Translation Module allows the user to consider any Record as a parent language Record and Translate the same into one or more languages of the user's choice, 20 and further all of the features and/or utility(s)/functionality(s) available in case of the parent language Record would be available in case of its Translation.

FIG. 25 is the diagram of the System Function of the Translation Module of the present invention. The architecture of this Module comprises of the following major functions, which allow a user to consider any Record as a parent language Record and Translate the same into one or more languages of the user's choice.

For the purpose of the Translation activity, the user:

Finds Record(s) from the Database(s) by none or one or more FIND conditions
Sorts and Selects Record(s)
Selects/Adds a language
Adds Translation(s)
Modifies Translation(s)
Deletes Translation(s)
Prints Record(s) by various Print conditions

FIG. 26 describes the System Operation of Translation Module explaining that the Module is based on user actions. The Translation Module is invoked within any data input Module like the Encyclopedia Bank Module.

The user first enters the Module for the Records of which the user wants to Translate. The Control System brings forth the User Interface of this Module from where the user can choose to Translate a Record. If the user continues, then the Control System brings forth the User Interface of the Translation Module wherein the user must enter/select a Language and enter the translation in that Language, in data input fields which correspond to those for the Record facing the user, considered as the parent Language Record. All the utility(s)/functionality(s) available in case of the parent Language Record are also available in case of its Translation. If the user chooses to save the Translation, the Control System saves the same as a Record in the Database(s), generates a new Record Id, and updates the Database(s). The user can find existing Translation(s) of -a Record by none or one or more FIND conditions. The user can further Modify or Delete an existing Translation of a Record, in the same manner as in case of a normal Record of the Module. The user comes out of the Module by closing the User Interfaces.

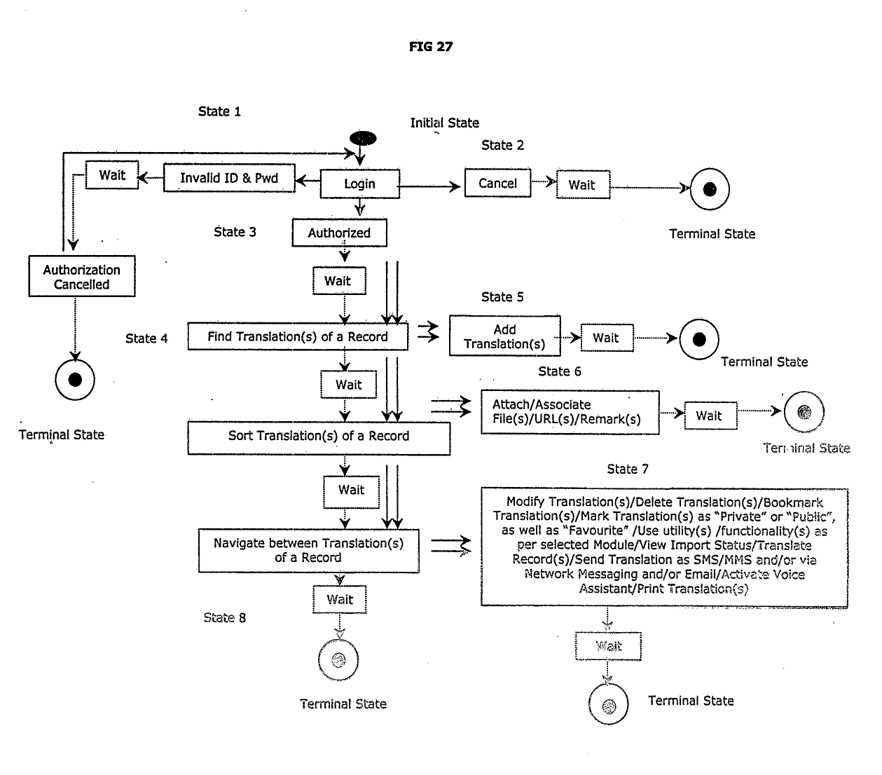

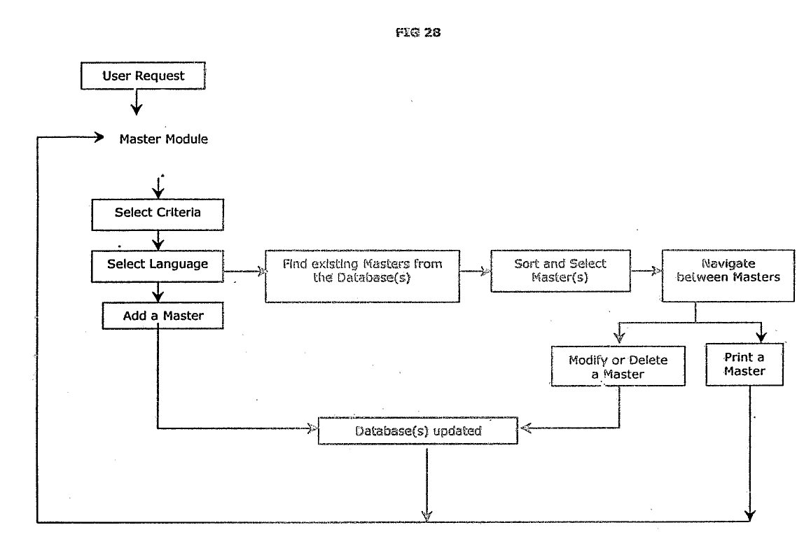

FIG. 27 describes the System State Transition of the Translation Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 28 to 30 explain the System Function, System Operation and System State Transition respectively, of the Master Module which provides the utility of creating, editing, deleting, printing, navigating, finding Masters like: User, Language, Source of Information, Age Group, Subject, and Sub Subjects. Sufficient security is provided by the System, so as not to allow tile deletion of any Master of a Record that may be in use.

FIG. 28 is the diagram of the System Function of the Master Module of the present invention. The architecture of this Module comprises of the following major functions, which allow a user to create and store Masters for Criteria with the help of the User Interface.

The Module allows a user to:

Select Criteria
Select Language
Add Master(s) for the selected Criteria
Copy Current Entry
Find existing Master(s) from the Database(s)
a Sort and Select Master(s)
Modify Master(s)
Delete Master(s)
Go To a Master and Navigate between Masters
Print Master(s)

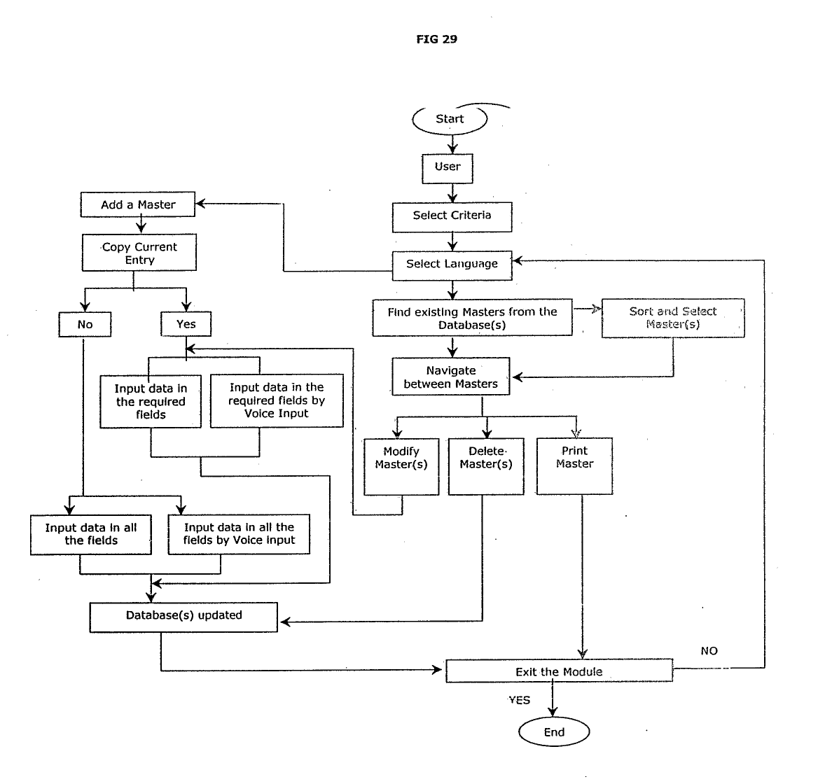

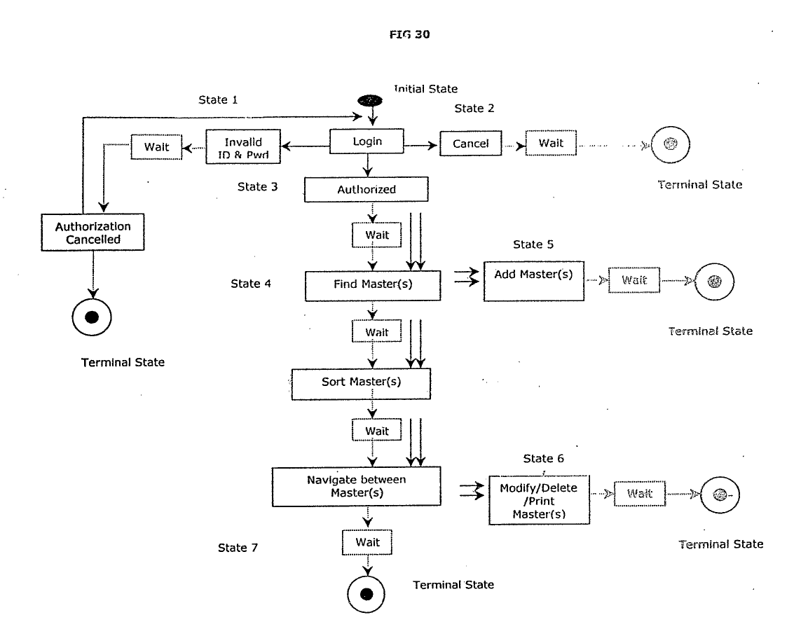

FIG. 29 describes the System Operation of the Master Module explaining that the Module is based on user actions. The Master Module accepts data in one or more languages (such data capable of being accepted from more than one user at the same time).

The user first selects the desired Criteria like User, Language, Source of Information, Age Group, Subject, and Sub Subjects for which the user wishes to create, find, modify, delete, print Masters, and then the Language in which the user wishes to do the same. The Control System brings forth a User Interface from where the user can Create Master(s), Find Master(s), Modify Master(s), Delete Master(s), Navigate between Master(s), Print Master(s), for the Criteria selected by the user. All of these functionalities are described below in detail.

The Create Master functionality allows the user to create a Master for the selected Criteria by allowing data input in the fields provided for the purpose in the User Interface described above. When the user chooses to create a Master, the Control System prompts the user as to whether or not the user wishes to copy the current Master, if any, facing the user. If a user chooses not to use this “Copy Current Entry” utility, then the Control System gets notified and blanks out the relevant data input field(s) for new data input by the user. The user can then enter data in the relevant data input field(s) as desired. After the user creates a new Master and chooses to save it, the Control System checks whether the new Master created by the user is a duplication of any Master created earlier. If the created Master is a duplication, then the Control System notifies the user that the user cannot create duplicate Masters and does not allow the user to save the Master. Else, the Control System saves the Master and updates the Database(s). The user can now use this Master for the selected Criteria at the time of adding or modifying Record(s) in any data input Module like Encyclopedia Bank Module.

The user can also create Masters by entering the same in the relevant data input fields when the user is adding or modifying Record(s) in any data input Module. The Masters thus created are also visible to the user through the Master Module. —EXAMPLE—If the user creates Masters through the Master Module for the Criteria of Subject-and Sub Subject(s) as SUBJECT>ANIMAL WORLD>SUB SUBJECT1>TERRESTRIAL ANIMAL>SUB SUBJECT2>MAMMAL, then the Masters like ANIMAL WORLD, TERRESTRIAL ANIMAL, and MAMMAL for Subject and Sub Subject(s) are available to the user, when the user is adding or modifying a Record in any of the data input Modules. Conversely, if the user creates Masters like the ones described above for Subjects and Sub Subjects by entering the same in the relevant data input fields when adding or modifying a Record in any of the data input Modules, then these Masters would be visible to the user in the Master Module. The Control System also updates the Database(s) in this case. If the user imports a Record into any data input Module, the Masters contained in the Record will also be visible to the user through the Master Module. The Control System also updates the Database(s) in this case. The Control System generates a new-Master Id each time a new Master is created and saved by the user in either of the ways described above or when a Record is imported by the user which contains relevant Masters for Criteria like User, Language, Source of Information, Age Group, Subject, and Sub Subjects.

The Voice functionality allows the user to create and/or Modify Master(s) by Voice Input as well as receive Voice Output of the Master(s). In case the user chooses to receive Voice Output of the Master(s), the Control System brings forth a text to speech agent that speaks out the Master(s). The user can choose between listening to the text to speech agent speak out the Master(s) continuously or one Master at a time.

The Find functionality allows the user to find existing Master(s) stored in the Database(s). If the user chooses to use this functionality, then the Control System brings forth a User Interface from where the user can find Master(s) by entering keywords.—EXAMPLE—If there is a Master ‘JUNIOR’ for the Criteria of Age Group stored in the Database(s) and the user types in just ‘JU’, then the ‘JUNIOR’ Master will appear in the Find Results. The same applies in case the user enters any part of the word ‘JUNIOR’ as a keyword. If the user does not enter any Keyword and chooses to Find Master(s), then the Control System brings forth Find Results showing all the Master(s) stored in the Database(s) for the selected Criteria. If a keyword entered by the user is not there in any of the Master(s), then the Control System notifies the user that no Master(s) have been found for the keyword entered by the user. The Control System brings forth a User Interface displaying the Find Results in a grid, from where the user can further Sort and group, the Masters currently displayed in the Find Result grid facing the user or the entire set of found Masters.

The Modify functionality allows the user to Modify a Master stored in the Database(s). If the user chooses to use this functionality then the user can use all the utility(s)/functionality(s) available at the time of creating a Master. After modification, if the user chooses to save the modification done to the Master, the Control System saves the same accordingly and updates the Database(s). Else, the modifications made by the user to the Master will not be saved. The modifications made by the user to the Master will be reflected in all the Record(s) which use that Master, in any data input Module.

The Delete functionality allows the user to Delete an existing Master stored in the Database(s). If the user chooses to use this functionality, the Control System prompts the user as to whether or not the user wishes to Delete that particular Master. If the user chooses to delete the Master, the Control System deletes the Master permanently from the System. The Control System updates the Database(s) in this case. However, if the Master to be deleted is being used by any Record in any data input Module, the Control System notifies the user that the Master is in use and hence cannot be deleted.

The Navigation functionality allows the user to navigate between the Masters stored in the Database(s).

The Printing functionality allows the user to print Master(s) stored in the Database(s).

If the user closes the User Interface described above, the Control System gets notified and the-user comes out from the Module.

FIG. 30 describes the System State Transition of the Master Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

Thus, while there have been shown and described and pointed out ,fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

### TECHNICAL APPLICATION TO THE INDUSTRY

The invention has several technical applications for the education industry. The invention has the potential to change the way in which encyclopedias are built, stored, modified and shared in the education industry.
1) The invention allows users to constantly modify data, allowing them to update their data as soon as information is updated, with a minimum amount of effort.

This would be a very helpful and timesaving utility, not only for students and teachers, but also for encyclopedia makers/publishers who can ensure that the most current information reaches their customers.
2) The invention facilitates ease of retrieval of information from the Encyclopedia, using a powerful Find utility that allows users to quickly search through a large database for specific data. Since the information is well classified, and available in one container, it eliminates the necessity of having to create and sort through many files and/or documents, thus reducing the time spent on such an activity.
3) The invention allows users to build a personalized and well-classified encyclopedia, with the possibility of additional information being stored. This would be useful for teachers and students, who can store specific information related to a particular subject or a topic, for a particular exam, and so on. This would also be of immense use to makers/publishers of encyclopedias, who could release specialized editions as per special guidelines and/or market requirements.
4) The invention allows users to Cross-reference information within the encyclopedia. This would be useful for teachers and students in increasing their scope of knowledge by linking together various pieces of information.
5) The invention also facilitates the sharing of information, through an Export/Import module. This utility can encourage the exchange of Information between different persons, organizations, or institutions, regardless of their physical location, thus helping create a larger common repository of knowledge for a wider audience.
6) The invention further allows a user to translate data from one language into another of the user's choice. This is particularly useful in case of encyclopedia publishers when they plan to publish encyclopedias in various languages.

The invention has many other useful features, such as allowing users to attach and associate audio-visual files in order to create more comprehensive data. The invention is also capable of distributing information through various mass media. Moreover, the invention has a provision for safeguarding confidential/proprietary content and prevents accidental deletion of the same

Mass-media and the Invention:

The use of the invention to the education industry can be optimized by exploring the potential of mass media. This can be seen as follows:
1) Publishing/Printing: The invention could be used by encyclopedia makers/publishers for the regular publishing of encyclopedias. Moreover, since the invention allows a detailed classification of information, subject-specific encyclopedias can be published with ease, for example, an “Encyclopedia of Computing Terms”.
2) The Internet: The invention can be used to create a repository of information to be used by all kinds of websites, either general in nature or focussing specifically on encyclopedias. In addition, it can also be used to send and receive information via E-mail and/or E-mail and/or Network Messaging.

1. An interactive system for building, organising, and sharing one's own Encyclopedia in one or more languages, using a computer system, and comprising of:
i) a User Interface;
ii) a well-classified Database comprising
a. an Encyclopedia Bank Database which is a reservoir of well-classified data and further stores the data user wise;
b. a Translation Database which is a reservoir of translated data;
c. a User Database which is a reservoir of user information and also contains the history of past user interaction with the System.
d. a Configuration Database which is the reservoir of the options used for the Customization of the System.
iii) a well classified data input organizing and management module enabling the user to classify the data by classifications selected or added in one or more of the groups consisting of Date, Language, Source of Information, Index Letter, Age Group, Subject, and Sub subjects (bearing a parent-child relationship) and Attach Image, Animation and/or Sound files and/or Associate more Information to the data in the form of URLs, Files, Remarks and such others individually, and further there is a utility which allows the user to globally Attach and/or Associate Files, URLs, Remarks to the data.

2. The System according to claim 1 further comprises a module allowing the user to Export data from the Database(s), such data having been selected by the user by finding the same by none or one or more FIND conditions.

3. The System according to claim 1 further comprises a module allowing the user to Import data built by another user using the same System.

4. The System according to claim 3 wherein the module allowing the user to Import data further comprises a utility which allows the user to selectively Import the data.

5. The System according to claim 1 wherein the data input organizing and management module allows the user to cross-reference data.

6. The System according to claim 1 wherein the data input organizing and management module comprises a utility for copying of existing classification and previously entered data for new data input by the user, for ease of data entry, with a choice of defining the extent of the details to be copied.

7. The System according to claim 1 wherein the data input organizing and management module allows the user to modify a Record individually and further comprises of a utility which allows the user to modify Records globally.

8. The System according to claim 1 wherein the data input organizing and management module allows the user to delete a Record individually and/or globally and further comprises of a utility which allows the user to restore or permanently remove a Record individually or plurally from the System that is deleted.

9. The System according to any one of the foregoing claims wherein the FIND conditions to find the Record(s) from the Database(s) are defined by none or one or more classifications like the Date, Record ID, Language, Source of Information, Index Letter, Age Group, Subject, and Sub subjects, as well as by keywords, wildcard characters, File Attachments, Associations, Attachment Remarks, Association Remarks, Import Remarks, or Bookmark Remarks including, but not limited to, whether or not the Record is marked as “Private” or “Public” or either, “Favourite”.
The user can exercise the option of using the above conditions to bring forth or avoid Records by the specified conditions.

10. The System according to claim 1 wherein the data input organizing and management module allows the user to find Records from the Database(s) which have similar classifications.

11. The System according to claim 1 wherein the data input organizing and management module allows the user to Bookmark as well as mark Records as “Public” or “Private”, as well as “Favourite”, individually and further there is a utility which allows the user to globally do the same.

12. The System according to claim 1 wherein the data input organizing and management module allows the user to Translate a Record from one language into one or more languages of the user's choice and further there is a utility which allows the user to globally translate Records.

13. The System according to any one of the foregoing claims wherein the modules and utilities are adapted to operate within a browser and/or other viewing and/or processing programs and to operate on one or more computer systems, including hand held devices.
